(19) United States
(12) Patent Application Publication
(10) Pub. No.: US 2026/0111086 A1
(43) Pub. Date: Apr. 23, 2026

(54) MULTIPLE-SENSOR ARRAY TOUCH-SENSING SYSTEM AND RELATED METHOD

(71) Applicant: UltraSense Systems, Inc., San Jose, CA (US)

(72) Inventors: Mo Li, Campbell, CA (US); Xiaoyue Jiang, San Jose, CA (US); Yonghuan David Ren, Milpitas, CA (US); Hao-Yen Tang, San Jose, CA (US)

(21) Appl. No.: 19/361,437

(22) Filed: Oct. 17, 2025

Related U.S. Application Data
(60) Provisional application No. 63/708,541, filed on Oct. 17, 2024.

(51) Int. Cl. G06F 3/044; G06F 3/01; G06F 3/041; G06F 3/043

(52) U.S. Cl. CPC G06F 3/044; G06F 3/016; G06F 3/04144; G06F 3/0436; G06F 2203/04106

(57) ABSTRACT

A touch-sensing system includes a cover stack, piezoelectric capacitors, and a signal processor. The piezoelectric capacitors are mechanically coupled to the cover stack at its inner interface. There is a first array of the piezoelectric capacitors which are configured as piezoelectric ultrasonic transducers (PUTs). There is a second array of the piezoelectric capacitors which are configured as piezoelectric force-measuring elements (PFEs). The signal processor is configured to receive PUT array signals from the PUTs and PFE array signals from the PFEs. The signal processor is configured to calculate PUT centroid data from the PUT array signals and PFE centroid data from the PFE array signals. The signal processor is configured to determine an estimated touch position on the cover stack by combining applicable centroid data including the PUT centroid data and the PFE centroid data.

### CROSS-REFERENCE TO RELATED APPLICATION(S)

This application claims the benefit of U.S. Provisional Patent Application No. 63/708,541 filed on Oct. 17, 2024, entitled “MULTIPLE-SENSOR ARRAY TOUCH-SENSING SYSTEM AND RELATED METHOD,” which is incorporated herein by reference in its entirety.

### BACKGROUND

Touch-sensing systems are a common interface to allow a user to interact with electrical devices such as smartphones, vehicles, computers, household appliances, industrial equipment, and other devices. Touch-sensing systems may employ capacitive-touch sensors. A capacitive-touch sensor may be sensitive to changes in capacitance caused by contact of an object (e.g., a finger) with a touch surface. In some cases, a capacitive-touch sensor may be sensitive to changes in capacitance caused by proximity of an object (e.g., a finger) to a touch surface. Accordingly, parameters such as the touch location may be determined. In some implementations, a touch-sensing system may be implemented as a slider; sliders are frequently found in applications where linear controls, such as volume controls, brightness controls, or controls of other parameters having a range of values. In some implementations, a touch-sensing system may be implemented as one or more control buttons. Control buttons are typically found in applications requiring discrete user inputs such as turning the power (or another suitable functionality) on or off, or selecting one or more of several options (with each control button being associated with a respective option), and so on. In one example, if each control button is associated with a respective letter or numeral, text may be input using control buttons. Herein, control buttons may sometimes be referred to as button. Touch-sensing systems based on capacitive-touch sensors may replace mechanical sliders and mechanical control buttons. Although in widespread use, capacitive-touch sensors are limited in some respects. One shortcoming of capacitive-touch sensors is that they are preferably incorporated on glass or other non-metallic substrates. Capacitive-touch sensors are typically not employed with metallic substrates. Another shortcoming of capacitive-touch sensors is that their performance can degrade in certain environmental conditions, including the presence of water, dust, or drift in temperature or humidity. Some environmental conditions may cause false positive detections of touch events or missed detections of touch events. Yet another shortcoming of capacitive-touch sensors is that they may be sensitive to touch by or proximity of an object to the touch surface when a user interaction is not intended. For example, the proximity of an electrically conductive object to the touch surface may unintentionally be detected as a touch event (e.g., detected signal above a predetermined threshold). Accordingly, touch-sensing systems that are not solely reliant on capacitive-touch sensors would be beneficial for some applications.

### BRIEF DESCRIPTION OF THE DRAWINGS

The disclosure may be more completely understood in consideration of the following detailed description of various embodiments of the disclosure in connection with the accompanying drawings, in which:

FIG. 1A is a schematic view of a portable electronic device in which an illustrative touch-sensing system may be implemented.

FIG. 1B is a schematic elevational view of an illustrative touch-sensing system (e.g., touch-sensing slider) in which the sensor assembly is adhered to the cover stack by an adhesive.

FIG. 1C is a schematic elevational view of an illustrative touch-sensing system (e.g., touch-sensing slider) in which the sensors are encapsulated in a molded package and a portion of the molded package is configured as the cover stack.

FIG. 2 is a schematic plan view of an array of touch-sensing elements (e.g., piezoelectric ultrasonic transducers (PUTs), piezoelectric force-measuring elements (PFEs)) extending along a longitudinal direction.

FIG. 3 is a schematic plan view of an array of touch-sensing elements (e.g., piezoelectric ultrasonic transducers (PUTs), piezoelectric force-measuring elements (PFEs)) extending along a longitudinal direction and another direction.

FIG. 4A is a schematic elevational view of a touch-sensing system (e.g., touch-sensing slider) according to some implementations. FIGS. 4B and 4C are schematic elevational views of respective implementations of piezoelectric capacitors (e.g., PUTs, PFEs) that may be employed in the touch-sensing system of FIG. 4A. In FIG. 4B, multiple piezoelectric capacitors (e.g., PUTs, PFEs) share a common piezoelectric member. In FIG. 4C, there is a separate piezoelectric member for each of the piezoelectric capacitors (e.g., PUTs, PFEs). FIG. 4D is a schematic elevational view of an alternative implementation in which the PUTs are piezoelectric micromechanical ultrasonic transducers (PMUTs) or the PFEs are piezoelectric micromechanical force-measuring elements (PMFEs) in a silicon substrate.

FIGS. 5, 6, and 7 are schematic elevational views of touch-sensing systems (e.g., touch-sensing sliders) according to some implementations. In the example shown in FIG. 5, the signal processor is housed in a separate packaged IC (e.g., microcontroller unit (MCU)). In the example shown in FIG. 6, one portion of the signal processor is housed in the separate packaged IC (e.g., MCU) and other portions of the signal processor are housed in the respective touch sensor devices (e.g., touch sensor ICs). In the example shown in FIG. 7, portions of the signal processor are housed in the respective touch sensor devices (e.g., touch sensor ICs).

FIG. 8 is a schematic elevational view of a sensor assembly according to some implementations, showing the arrangement of the electrodes of the piezoelectric capacitors (PUTs, PFEs) and the electrical connections between these electrodes and input/output (I/O) electrodes (e.g., I/O pads).

FIG. 9A is a schematic elevational view of a sensor assembly according to some other implementations, showing the arrangement of the electrodes of the piezoelectric capacitors (PUTs, PFEs) and the electrical connections between these electrodes and input/output (I/O) electrodes (e.g., I/O pads). The arrangement of FIG. 9A differs from the arrangement of FIG. 8 in that the piezoelectric capacitors (PUTs, PFEs) share a common electrode (in the example shown, a common upper electrode). FIG. 9B is a schematic plan view of the array of piezoelectric capacitors (PUTs, PFEs).

FIG. 10A is a schematic elevational view of a sensor assembly according to some other implementations, showing the arrangement of the electrodes of the piezoelectric capacitors (PUTs, PFEs). The arrangement of FIG. 10A differs from the arrangements of FIG. 8 and FIG. 9A in that the piezoelectric capacitor (PUT, PFE) electrodes also function as I/O electrodes. FIG. 10B is a schematic elevational view of a touch-sensing system (e.g., touch-sensing slider) that incorporates the sensor assembly of FIG. 10A.

FIGS. 11A and 11B are schematic diagrams of touch-sensing systems according to some implementations.

FIG. 12A is a schematic plan view of a touch-sensing system implemented as a button.

FIG. 12B is a schematic cross-sectional view of the touch-sensing system of FIG. 12A.

FIGS. 12C, 12D, 12E, 12F, and 12G are schematic cross-sectional views of other touch-sensing systems implemented as buttons.

FIGS. 13A and 13B are flow diagrams of processes of sensing touch according to some implementations.

FIGS. 14A, 14B, and 14C schematically illustrate the combination of PUT centroid data and PFE centroid data in accordance with respective fractional weights of the PUT centroid data and the PFE centroid data.

FIG. 14D (Table 1) shows example PUT signal-to-noise ratios (SNRs), PFE SNRs, PUT fractional weighting factors, and PFE fractional weighting factors.

FIG. 15 is a flow diagram of a process of sensing touch according to some implementations.

FIG. 16 (Table 2) shows one example of a calculation of centroid data from sensor array signals (e.g., PUT array signals, PFE array signals, additional sensor array signals).

FIG. 17A is a schematic timing diagram showing the relationships among the signal portions of the signals received by the signal processor from the PUTs during a sensing event time frame.

FIG. 17B is a schematic timing diagram showing the relationships among the sensing event time frames and the signal processing time frames during a touch determination period.

FIG. 18 is a schematic diagram of the response curves of three illustrative touch-sensing elements, illustrating a concept of determining a touch location.

FIG. 19 is a schematic view of an illustrative touch-sensing system (e.g., touch-sensing slider) that additionally includes a wake-up sensor.

FIG. 20 is a schematic view of an illustrative touch-sensing system (e.g., touch-sensing slider) in which the signal processor is configured to receive wake-up signals from an external source.

FIG. 21 is a flow diagram of a method of sensing touch in accordance with some embodiments.

FIG. 22 is a schematic plan view of an array of PUTs including transmitting-type PUTs and receiving-type PUTs.

FIG. 23A is a schematic view of waves transmitted by transmitting-type PUTs, in which the waves transmitted from one of the PUTs are independent of the waves transmitted by another of the PUTs. FIG. 23B is a schematic view of waves transmitted by transmitting-type PUTs, in which the waves interfere constructively to form a converging wavefront.

FIG. 24A is a schematic plan view of an array of PUTs. FIG. 24B is a table of transducer states for each of the PUTs of FIG. 18 at a plurality of sensing time windows.

FIG. 25 is a flow diagram of a process of making a monolithic IC (integrated circuit) incorporating a CMOS (complementary metal-oxide semiconductor) portion and a MEMS (micro-electro-mechanical systems) portion.

FIG. 26 is a flow diagram of a process of making a wafer-bonded IC incorporating a CMOS (complementary metal-oxide semiconductor) wafer portion and a MEMS (micro-electro-mechanical systems) wafer portion.

FIG. 27 is a flow diagram of a process of making a system in a package (SiP) incorporating a CMOS IC and a MEMS IC.

FIG. 28 is a flow diagram of a process of making a touch sensor device incorporating discrete (e.g., non-micromechanical) piezoelectric capacitors.

### DETAILED DESCRIPTION

The present disclosure relates to a touch-sensing system which incorporates an array of piezoelectric capacitors configured as piezoelectric ultrasonic transducers (PUTs) and piezoelectric force-measuring elements (PFEs). In some implementations, the touch-sensing system may be implemented as virtual button in which the user input depends upon factors such as location of the user's touch (e.g., touch by a user's finger) and pressure and chronological pattern of the user's touch (e.g., light touch and release, press and release, press and hold, multiple presses). In some implementations, the touch-sensing system may be implemented as a virtual slider in which the user's finger slides along a predetermined surface and the user input depends on factors such as (1) the start position and/or the end position of the user's finger sliding along the predetermined surface, and (2) the speed at which the finger slides along the predetermined surface. In some implementations, the touch-sensing system may be implemented as a virtual button at some times (“virtual button mode”) and as a virtual slider (“virtual slider mode”) at some other times. For example, in the virtual button mode, the touch-sensing system may receive user input indicating that a video player is to be activated. In a subsequent virtual slider mode, the touch-sensing system may receive a user input indicating a volume of the audio for the video player. A touch-sensing system can be used in various applications to provide a user-friendly and intuitive interface. For example, a touch-sensing system can be used in mobile devices (e.g., smartphones, tablet computers, laptop computers), household appliances (e.g., washing machines, dryers, light switches, kitchen appliances, remote control devices), medical devices, industrial appliances, office appliances, musical instruments, automobile interfaces, fitness equipment, home or office HVAC controls or automation, etc.

In this disclosure, the words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention. The recitations of numerical ranges by endpoints include all numbers subsumed within that range (e.g., 1 to 5 includes 1, 1.5, 2, 2.75, 3, 3.80, 4, 5, etc.). 1For any method disclosed herein that includes discrete steps, the steps may be conducted in any feasible order. As appropriate, any combination of two or more steps may be conducted simultaneously.

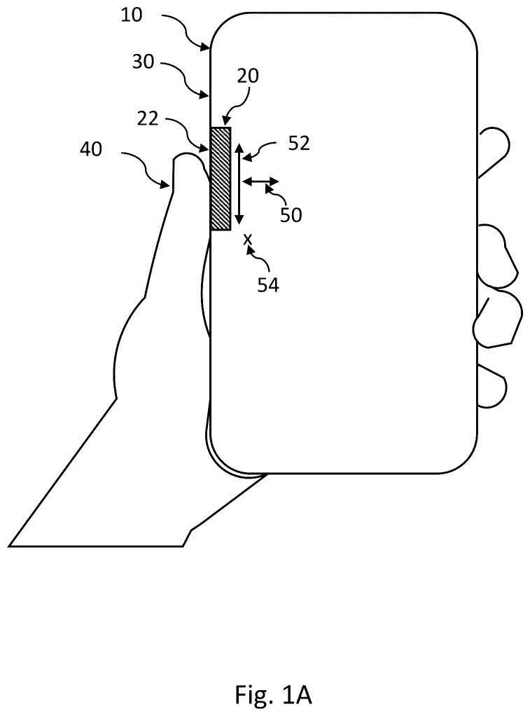

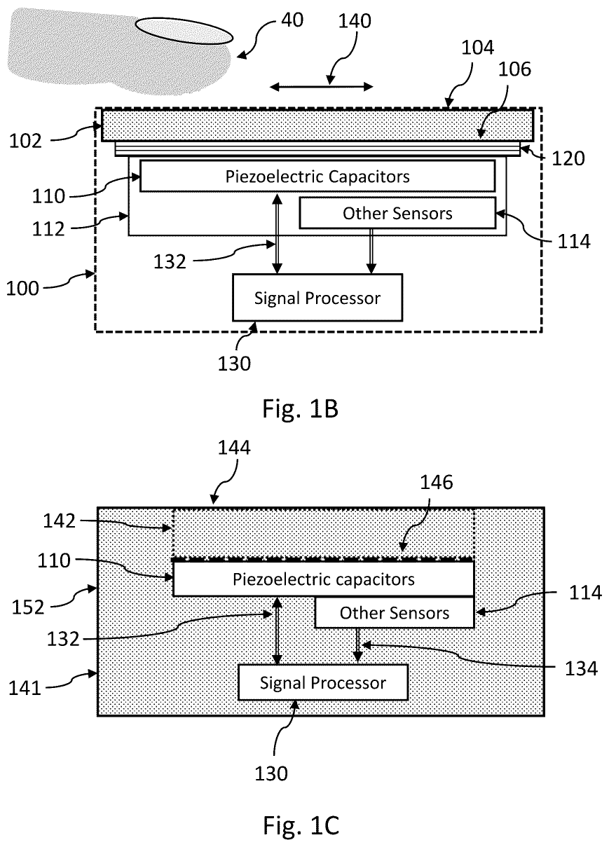

FIG. 1A is a schematic view of a portable electronic device 10 (e.g., a smartphone) including a touch-sensing system 20 in accordance with embodiments of the present technology. In the example shown, the touch-sensing system 20 is positioned along a side edge 30 of portable electronic device 10. The touch-sensing system 20 includes a cover stack having an outer surface 22. Outer surface 22 is exposed and can be touched by a user's finger 40. A variety of user inputs are possible. In some examples, the user can apply a light touch and release, press and release, press and hold, or multiple presses (multiple instances of press and release). In these examples, the finger may apply a force along a transverse direction 50. In some other examples, the finger may swipe (slide) across the outer surface (while in contact with the outer surface) (e.g., along a longitudinal direction 52) and the user input may user input may depend on factors such as (1) the start position and/or the end position of the user's finger sliding along the predetermined surface (e.g., outer surface), (2) the speed at which the finger slides along the predetermined surface, and (3) the force with which the finger presses against the predetermined surface. In some implementations, the user may receive haptic feedback such as vibration or motion from the touch-sensing system 20. In some examples, the vibration may be along a transverse direction 50 or along the longitudinal direction 52 or another direction 54 perpendicular to the transverse direction 50 and the longitudinal direction 52 or a combination of any of the foregoing directions. The haptic feedback may vary in intensity, duration, and pattern, depending on the settings of the electronic device 10, the settings of the touch-sensing system 20, and the specific interaction being performed. In some embodiments, the touch-sensing system can be a discrete module coupled to (e.g., attached to) the frame of the electronic device 10 and electronically connected to control circuitry of the electronic device 10.

FIG. 1B is a schematic elevational view of an illustrative touch-sensing system 100. The touch-sensing system 100 includes a cover stack 102, a sensor assembly 110, and a signal processor 130. The cover stack has an outer surface 104 which can be touched by a finger 40. Cover stack 102 can be made from any robust material layer(s) though which ultrasound waves can propagate. Ultrasound waves are also sometimes referred to as ultrasonic waves. Materials suitable for use in a cover stack include metals (aluminum, aluminum alloy, steel) and electrically non-conductive materials such as wood, glass, plastic, leather, fabric, and ceramic. The cover stack may be a single layer of material or may comprise multiple layers of materials. The cover stack may be electrically non-conductive. The cover stack may comprise any suitable material singly or in combination. In the example shown, sensor assembly 110 is encapsulated in a protective package 112. For example, sensor assembly 110 can be a MEMS device or can comprise discrete elements (e.g., piezoelectric member(s), substrate(s), wiring, electrode(s)), and be encapsulated in a package 112. Signal processor 130 is connected via a bus (or other signal interconnection) 132 to sensor assembly 110. Signal processor 130 is configured to receive signals from sensor assembly 110 while sensor assembly 110 is active during a touch determination period. Sensor assembly 110 is mechanically coupled to cover stack 102 at its inner interface 106. In the example shown, sensor assembly 110, in its packaged form, is adhered to cover stack 102 at the inner interface 106 by an adhesive. Some examples of suitable adhesives are: double-sided tape, pressure sensitive adhesive (PSA), epoxy adhesive, or acrylic adhesive. The cover stack 102 has a longitudinal direction 140 along which a finger can touch and slide on outer surface 104. Optionally, touch-sensing system 100 can also include other sensors 114.

FIG. 1C is a schematic elevational view of another illustrative touch-sensing system 141. The touch-sensing system 141 includes a sensor assembly 110, a signal processor 130, and a bus (or other signal interconnection) 132, as described with reference to FIG. 1A. In the example shown, sensor assembly 110, signal processor 130, bus 132, and other components (not shown) are encapsulated in a molded package 152. Materials that are typically employed for forming the molded package are robust materials such as plastic, metal, and ceramic. In this implementation, a portion of the molded package 152 is configured as a cover stack 142: cover stack 142 has an outer surface 144 which can be touched by a finger, and an inner interface 146 at which sensor assembly 110 is mechanically coupled. The cover stack portion 142 of molded package 152 is in the region between outer surface 144 and sensor assembly 110; sensor assembly 110 is configured to sense touch events that occur at the outer surface. Optionally, touch-sensing system 100 can also include other sensors 114.

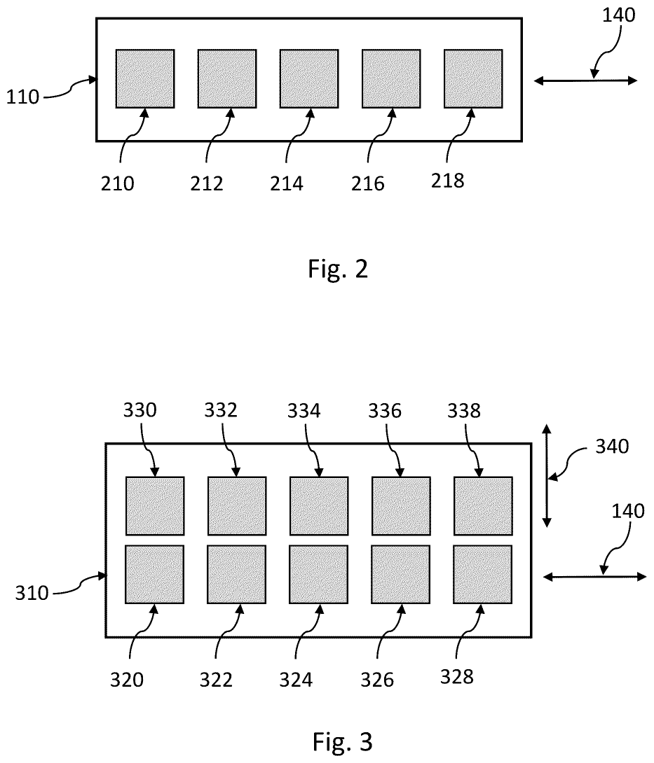

FIG. 2 is a schematic plan view of an illustrative sensor assembly 110, which includes an array of touch-sensing elements (210, 212, 214, 216, 218) extending along a longitudinal direction 140. FIG. 3 is a schematic plan view of another illustrative sensor assembly 310, which includes an array of touch-sensing elements. Touch-sensing elements 320, 322, 324, 326, and 328 are arrayed along longitudinal direction 140. Touch-sensing elements 330, 332, 334, 336, and 338 are arrayed along longitudinal direction 140. Touch-sensing elements 320 and 330 are arrayed along another direction 340, which in the example shown is approximately perpendicular to longitudinal direction 140. Similarly, touch-sensing elements 322 and 332 are arrayed along other direction 340, and so on. The touch-sensing elements may be piezoelectric capacitors configured as piezoelectric ultrasonic transducers (PUTs) (including piezoelectric micromechanical ultrasonic transducers (PMUTs)), as explained herein. Additionally, in some implementations, piezoelectric capacitors may be configured as piezoelectric force-measuring elements (PFEs) (including piezoelectric micromechanical force-measuring elements (PMFEs)).

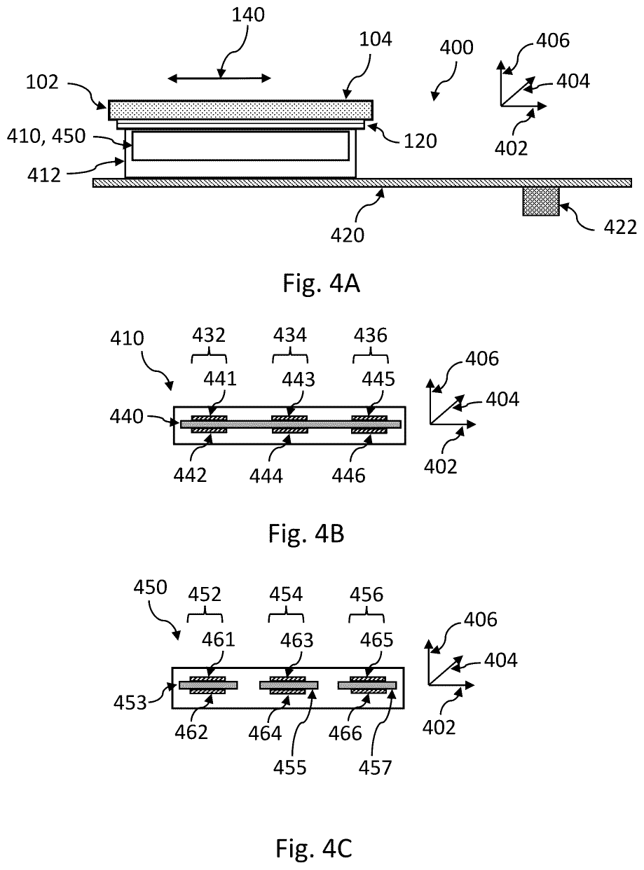

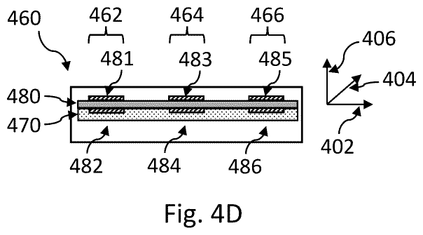

FIG. 4A is a schematic elevational view of a touch-sensing system 400 according to some implementations. Touch-sensing system 400 includes a cover stack 102 and a sensor assembly (e.g., 410 or 450) encapsulated in a package 412 and adhered to cover stack 102 by an adhesive 120. An orthogonal coordinate system is shown: x-axis 402, y-axis 404, and z-axis 406. In the example shown, longitudinal direction 140 is approximately parallel to x-axis 402. Sensor assembly 410 is described with reference to FIG. 4B and sensor assembly 450 is described with reference to FIG. 4C. Touch-sensing system 400 also includes a signal processor 422, which is shown as a separate IC (e.g., an application-specific integrated circuit (ASIC) comprising a signal processor such as an MCU). The sensor assembly and the signal processor are mounted to a circuit board substrate 420 (e.g., a printed circuit board (PCB), flexible substrate). Not shown are electrical interconnections on or in the circuit board substrate between the sensor assembly and signal processor 422. Also not shown are other components (e.g., other ICs, other transducers, power supplies, batteries) that may be connected to the circuit board substrate 420.

FIGS. 4B and 4C are schematic elevational views of respective sensor assemblies 410, 450 that may be employed in the touch-sensing system of FIG. 4A. In some implementations, sensor assemblies 410, 450 may comprise discrete (e.g., non-micromechanical) piezoelectric capacitors. In such cases, the sensor assemblies may be larger than typical MEMS ICs. In FIG. 4B, sensor assembly 410 includes piezoelectric capacitors 432, 434, 436 (e.g., configured as piezoelectric ultrasonic transducers (PUTs) or piezoelectric force-measuring elements (PFEs)) as the touch-sensing elements. For each piezoelectric capacitor, there is an upper electrode (441, 443, or 445), a lower electrode (442, 444, or 446), and a common capacitor dielectric (piezoelectric member) 440, shared by the three piezoelectric capacitors, between the upper electrodes and the lower electrodes. In the example shown, the capacitor dielectric 440 is a free-standing piezoelectric member (e.g., film). A free-standing piezoelectric member may be employed for discrete (e.g., non-micromechanical) piezoelectric capacitors. Suitable piezoelectric materials for a piezoelectric member include aluminum nitride, scandium-doped aluminum nitride, polyvinylidene fluoride (PVDF), lead zirconate titanate (PZT), potassium sodium niobate (KₓNa₁₋ₓNbO₃) (KNN), barium titanate (BaTiO₃) (BT), bismuth ferrite (BiFeO₃) (BFO), quartz, zinc oxide, lithium niobate, or bismuth sodium titanate (Bi_{0.5}Na_{0.5}TiO₃) (BNT). An example of a suitable piezoelectric material for a free-standing piezoelectric member is PZT. In the example shown, the cross-talk among nearby piezoelectric capacitors (PUTs, PFEs) is sufficiently low so that multiple piezoelectric capacitors (PUTs, PFEs) can share a common piezoelectric member (e.g., piezoelectric layer 440) with no appreciable degradation in performance. In some cases, manufacturing costs may be reduced by adopting designs in which multiple piezoelectric capacitors (PUTs, PFEs) share a common piezoelectric member.

In FIG. 4C, there is a separate piezoelectric member for each of the piezoelectric capacitors (PUTs, PFEs). In FIG. 4C, sensor assembly 450 includes piezoelectric capacitors 452, 454, 456 (configured as PUTs and/or PFEs) as the touch-sensing elements. For each piezoelectric capacitor, there is an upper electrode (461, 463, or 465), a lower electrode (462, 464, or 466), and a piezoelectric member (453, 455, or 457) between them. For example, the piezoelectric member (453, 455, or 457) may be formed by dicing a larger piezoelectric substrate into individual pieces.

Consider the case of configuring the piezoelectric capacitors as PUTs. Each of the PUTs may be configured to operate in a transmitting mode or a receiving mode. For example, consider PUT 452 (FIG. 4C). In a transmitting mode, upon application of a time-varying electric field between the electrodes (461, 462), the piezoelectric layer (piezoelectric member) 453 undergoes a contraction and expansion which results in mechanical motion (e.g., motion in the thickness direction, motion along a radial direction, shear motion, and/or flexural motion) of the piezoelectric member 453. For example, this time-varying electric field may be generated by the application of a time-varying voltage signal that is generated and amplified at the signal processor (422) and transmitted to the PUTs. As a result of the mechanical motion, ultrasound waves (of a predetermined frequency) are transmitted in a normal direction (z-axis 406 direction) (i.e., in the z-direction normal to the x-y plane in which the piezoelectric layer extends). In a touch-sensing system 400, at least a portion of the transmitted ultrasound waves reach outer surface 104 of cover stack 102, where the ultrasound waves may be attenuated by absorption by an object (e.g., a finger in contact with outer surface 104). At least a portion of the ultrasound waves are reflected back toward PUT 452. In a receiving mode, ultrasound waves (e.g., reflected ultrasound waves) of the predetermined frequency that are incident on the piezoelectric member 453 cause flexural motion of the piezoelectric member 453. As a result, time-varying voltage signals are generated between the electrodes (461, 462), which undergo signal conditioning (e.g., amplification, analog-to-digital conversion, other signal conditioning processes) before or after being received by a signal processor. The signal processor may determine, from the signals, whether a touch event has occurred, because of the greater attenuation of the ultrasound waves by the object touching the cover stack compared to when there is no touch. The signal processor may determine (1) a touch event has occurred when the received signal corresponds to an attenuation of the ultrasound waves greater than a predetermined threshold, and (2) a touch event has not occurred when the received signal corresponds to an attenuation of the ultrasound waves smaller than a predetermined threshold.

In some implementations, MEMS technologies may be employed to make MEMS ICs that incorporate piezoelectric capacitors. FIG. 4D is a schematic elevational view of an implementation in which the PUTs are piezoelectric micromechanical ultrasonic transducers (PMUTs) or the PFEs are piezoelectric micromechanical force-measuring elements (PMFEs) in a silicon substrate. In FIG. 4D, sensor assembly (e.g., MEMS-type sensor assembly) includes piezoelectric capacitors 462, 464, 466 (configured as PMUTs and or PMFEs) as the touch-sensing elements. For each piezoelectric capacitor, there is an upper electrode (481, 483, or 485), a lower electrode (482, 484, or 486), and a piezoelectric layer (480) between them. In some implementations, aluminum nitride may be employed as a piezoelectric material in a piezoelectric capacitor (PMUT, PMFE). Aluminum nitride (AlN) may be preferred in some implementations because of its compatibility with CMOS processing technologies. In the example shown, the piezoelectric layer 480 has been deposited on a substrate 470 by a suitable process known in the art. The substrate 470 (and the piezoelectric layer 480) extend along the x-axis 402 direction and the y-axis 404 direction. Substrate 470 may be a silicon substrate (e.g., silicon wafer on which the MEMS layers are deposited) or a previously deposited aluminum nitride layer which may also function as a mechanical layer. In the example shown, the lower electrodes (482, 484, 486) are formed on the substrate 470, and then the piezoelectric layer 480 is formed on the lower electrodes (482, 484, 486) and the substrate 470. Accordingly, the piezoelectric layer 480 is sandwiched by the lower and upper electrodes with no intervening substrate material.

In the foregoing description (FIG. 4C), piezoelectric capacitor 452 was described as being configured as a transmitting-type PUT and a receiving-type PUT. In addition, a piezoelectric capacitor (e.g., 452, 454, 456) may be configured as piezoelectric force-measuring elements (PFEs). For example, a piezoelectric capacitor may be configured as a transmitting-type PUT during a first time period, a receiving-type PUT during a second time period, and a PFE during a third time period. When a transient force is applied at cover stack 102 (e.g., by a finger touching or pressing cover stack 102 at outer surface 104), the transient force is transmitted to the neighboring PFEs (e.g., 452). The transient force causes a low-frequency mechanical deformation of the PFE, which in turn causes a contraction (e.g., compressive stress) and/or expansion (e.g., tensile stress) of the piezoelectric member (e.g., 453). As a result, time-varying voltage signals are generated between the respective electrodes (e.g., 461 and 462) of a PFE. These time-varying voltage signals may undergo signal conditioning (e.g., amplification, analog-to-digital conversion, other signal conditioning processes) before or after being received by the signal processor. The signal processor may estimate (1) a transient strain (e.g., transient strain at the piezoelectric member) or (2) a transient applied force (e.g., transient force applied by a finger at the outer surface of the cover stack) from the time-varying voltage signals. The PFEs are sensitive to transient strain and may be distinguished from other elements that are sensitive to steady-state strain such as a strain gauge.

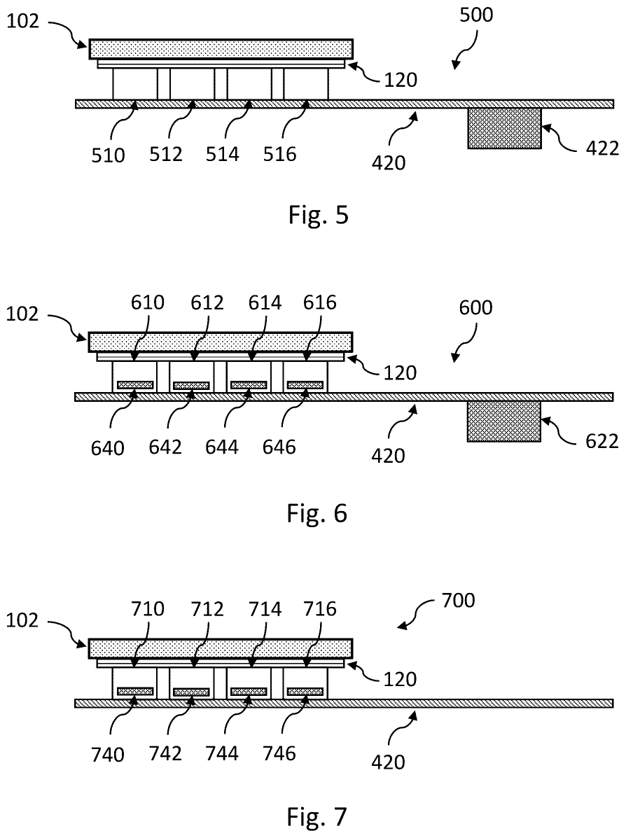

FIGS. 5, 6, and 7 are schematic elevational views of touch-sensing systems according to some implementations, illustrating some variations in the arrangement of the signal processor. FIG. 5 shows a touch-sensing system 500 comprising multiple touch sensor devices (510, 512, 514, 516), adhered to a cover stack 102 via an adhesive 120. The touch sensors are mounted to a circuit board substrate 420. The signal processor 422 is housed in a packaged IC (e.g., microcontroller unit (MCU)), separate from the touch sensor devices. In the example shown in FIG. 6, one portion of the signal processor (622) is housed in a separate packaged IC and other portions of the signal processor (640, 642, 644, 646) are housed in the respective touch sensor devices (610, 612, 614, 616). In the example shown in FIG. 7, there is no portion of the signal processor separate from the touch sensor devices. Instead, portions of the signal processor (740, 742, 744, 746) are housed in the respective touch sensor devices (710, 712, 714, 716). Each of the touch sensor devices shown in FIGS. 5, 6, and 7 (e.g., 510, 610, 710) may be implemented as a device comprising (1) a discrete piezoelectric capacitor (PUT, PFE) array, including, e.g., free-standing piezoelectric member and electrodes deposited or otherwise formed on the piezoelectric member, and (2) a signal processor implemented as an application-specific integrated circuit (ASIC), for example. In other instances, a touch sensor device may be implemented as a packaged IC (e.g., a touch sensor IC). A touch sensor IC may include a MEMS portion (including PMUT, PMFE elements) and a CMOS portion incorporating signal processing capabilities (e.g., 640, 740). A touch sensor IC may incorporate varying levels of signal processing capability (e.g., touch sensor device 510 has a relatively low level of signal processing capability, touch sensor device 710 has a relatively high level of signal processing capability, and touch sensor device 610 has a signal processing capability intermediate between touch sensor devices 510 and 710).

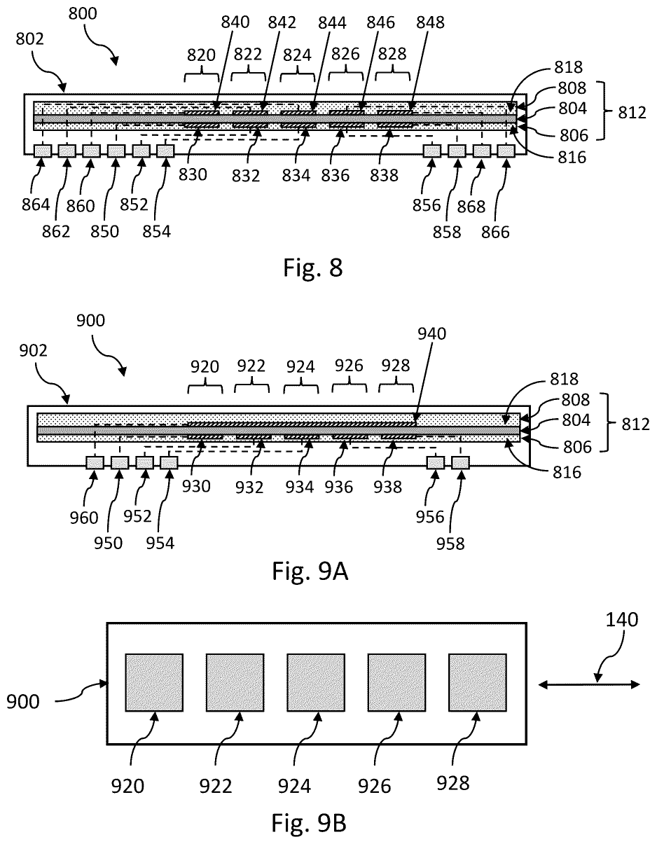

FIG. 8 is a schematic elevational view of a sensor assembly 800 according to some implementations. Sensor assembly 800 is encapsulated in a package 802. A piezoelectric member (e.g., layer or film) 804 extends across sensor assembly 800. In the example shown, mechanical layers 806 and 808 are adjacent to and attached to the piezoelectric member at its lower surface 816 and upper surface 818, respectively. Piezoelectric member 804, lower mechanical layer 806, and upper mechanical layer 808 constitute a piezoelectric stack 812. Lower mechanical layer 806 and/or upper mechanical layer 808 are optional and may be employed to modify the mechanical or other properties of piezoelectric stack 812, as compared to piezoelectric member 804 by itself. In some implementations, a substrate (e.g., Si substrate) may function as a mechanical layer upon which the piezoelectric layer is deposited or otherwise formed. Sensor assembly 800 includes piezoelectric capacitors (PUTs, PFEs) 820, 822, 824, 826, and 828, which function as touch-sensing elements. Each piezoelectric capacitor (PUT, PFE) (820, 822, 824, 826, 828) includes a respective portion of the piezoelectric member 804, a respective lower electrode (830, 832, 834, 836, 838), and a respective upper electrode (840, 842, 844, 846, 848). The single piezoelectric member 804 is shared among these piezoelectric capacitors (PUTs, PFEs). In the example of sensor assembly 800, input/output (I/O) connections are made at the bottom of the sensor assembly. Ten I/O electrodes, serving the five piezoelectric capacitors, are shown: electrodes 850 and 860 connected to piezoelectric capacitor 820, electrodes 852 and 862 connected to piezoelectric capacitor 822, electrodes 854 and 864 connected to piezoelectric capacitor 824, electrodes 856 and 866 connected to piezoelectric capacitor 826, and electrodes 858 and 868 connected to piezoelectric capacitor 828. Dotted lines show the interconnections between the I/O electrodes and the electrodes of the piezoelectric capacitors.

FIG. 9A is a schematic elevational view of a sensor assembly 900 according to some other implementations. Sensor assembly 900 is encapsulated in a package 902. Sensor assembly 900 includes piezoelectric capacitors (PUTs, PFEs) 920, 922, 924, 926, and 928, which function as touch-sensing elements. The arrangement of FIG. 9A differs from the arrangement of FIG. 8 in that the piezoelectric capacitors share a common electrode (in the example shown, a common upper electrode 940). Accordingly, there are six I/O electrodes serving the five piezoelectric capacitors: electrode 960 connected to common piezoelectric capacitor electrode (upper electrode) 940, electrode 950 connected to bottom electrode 930 of piezoelectric capacitor 920, electrode 952 connected to bottom electrode 932 of piezoelectric capacitor 922, electrode 954 connected to bottom electrode 934 of piezoelectric capacitor 924, electrode 956 connected to bottom electrode 936 of piezoelectric capacitor 926, and electrode 958 connected to bottom electrode 938 of piezoelectric capacitor 928. Dotted lines show the interconnections between the I/O electrodes and the electrodes of the piezoelectric capacitors. The implementation of FIG. 9A reduces the number of piezoelectric capacitor electrodes, I/O electrodes, and piezoelectric capacitor-to-I/O interconnections, compared to the implementation of FIG. 8. FIG. 9B is a schematic plan view of the array of piezoelectric capacitors as shown in elevational view in FIG. 9A. The piezoelectric capacitor array extends along a longitudinal direction 140.

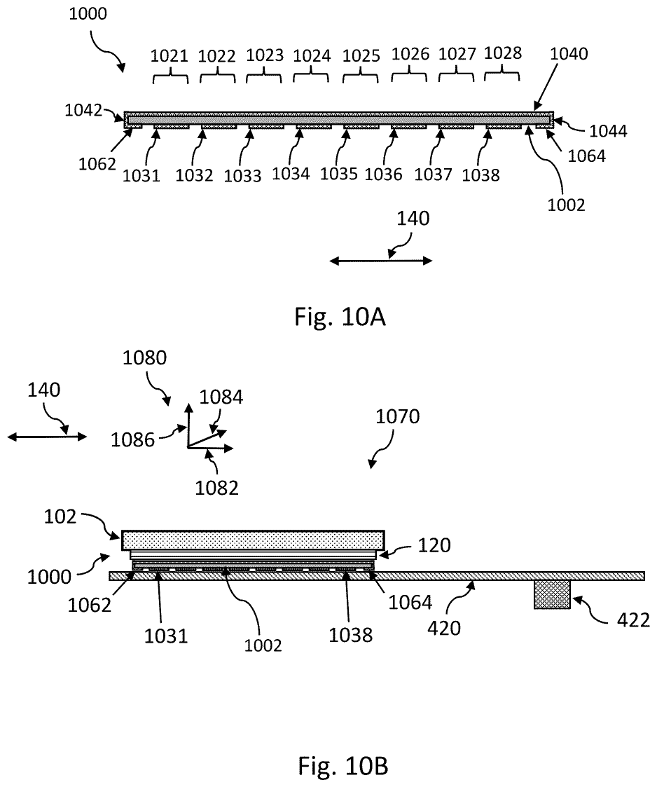

FIG. 10A is a schematic elevational view of a sensor assembly 1000 according to some other implementations. Sensor assembly 1000 includes a piezoelectric member 1002 in the form a free-standing film. In the example shown, mechanical layers have been omitted. In the example shown, sensor assembly 1000 is not encapsulated in any package. A common upper piezoelectric capacitor (PUT, PFE) electrode 1040 is shared among the piezoelectric capacitors 1021, 1022, 1023, 1024, 1025, 1026, 1027, and 1028. Each of the piezoelectric capacitors includes a respective lower electrode (1031, 1032, 1033, 1034, 1035, 1036, 1037, and 1038). Upper electrode 1040 wraps around from the top to the bottom of the piezoelectric member 1002. Electrode portion 1042 wraps around piezoelectric member 1002 along its left edge to an electrode extension 1062 near the bottom left of piezoelectric member 1002. Similarly, electrode portion 1044 wraps around piezoelectric member 1002 along its right edge to an electrode extension 1064 near the bottom right of piezoelectric member 1002. Note that one of these electrode extensions (1062 or 1064) may be omitted. The arrangement of FIG. 10A differs from the arrangements of FIG. 8 and FIG. 9A in that the piezoelectric capacitor electrodes also function as I/O electrodes. The piezoelectric capacitor array extends along longitudinal direction 140.

FIG. 10B is a schematic elevational view of touch-sensing system 1070 that incorporates sensor assembly 1000 of FIG. 10A. In the example shown, sensor assembly 1000 is mounted to a circuit board substrate 420. For example, all piezoelectric capacitor (PUT, PFE) electrodes (e.g., 1062, 1031, 1038, 1064, etc.) are bonded (e.g., bonded by soldering (solder-bonded), bonded by conductive adhesive) directly to respective electrodes on the circuit board substrate 420. Sensor assembly 1000 is adhered to cover stack 102 via an adhesive 120 at the upper surface of sensor assembly 1000. A signal processor 422 is also mounted to the circuit board substrate and is electrically coupled to the piezoelectric capacitors (e.g., configured to send signals to and receive signals from the PUTs, configured to received signals from the PFEs). The piezoelectric capacitor array extends along longitudinal direction 140. An orthogonal coordinate system 1080 includes an x-axis 1082 (shown as being approximately parallel to the longitudinal direction 140), a y-axis 1084 (directed into the page), and a z-axis 1086 (normal to the plane formed by the x- and y-axes). In the example shown, piezoelectric member 1002 extends along the x- and y-axes. Accordingly, z-axis 1086 is approximately normal to the plane of the piezoelectric member 1002.

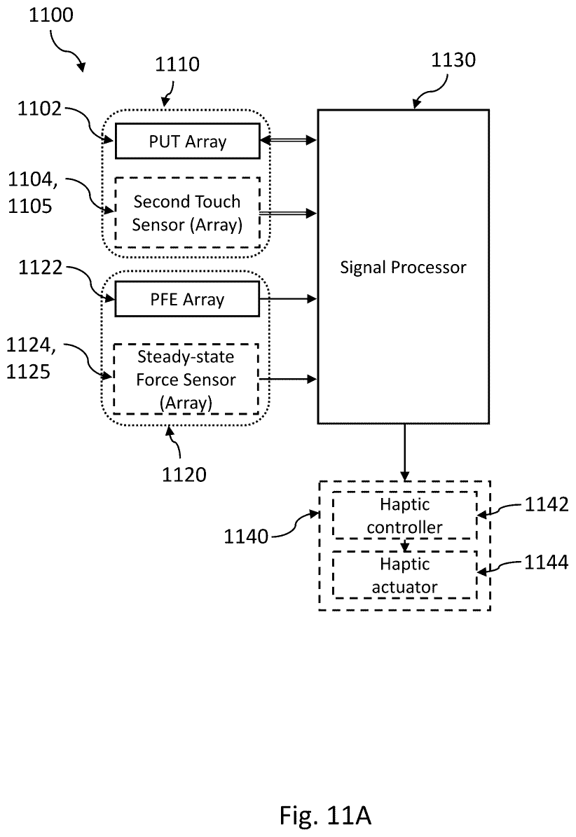

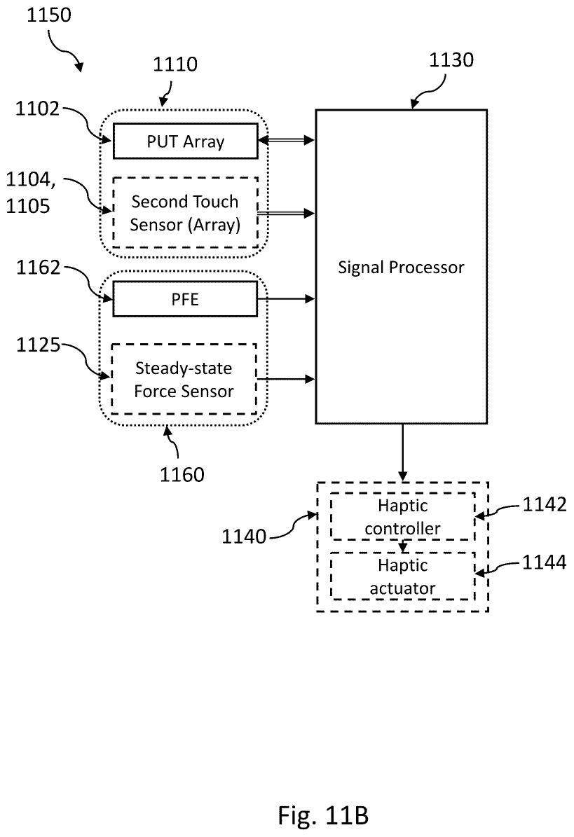

FIG. 11A is a schematic diagram illustrating certain signal-generating and signal-processing aspects of a touch-sensing system 1100 in accordance with some embodiments. Touch-sensing system 1100 includes piezoelectric capacitors that are mechanically coupled to the cover stack, as described elsewhere herein. The piezoelectric capacitors include a first array of piezoelectric capacitors configured as PUTs (1102) and a second array of piezoelectric capacitors configures as PFEs (1122). The first and second array of piezoelectric capacitors can be the same or different. At least two of the piezoelectric capacitors are configured as PUTs and at least two of the piezoelectric capacitors are configured as PFEs. In some implementations, the touch-sensing system 1100 may include a second touch sensor array 1104 and/or a steady-state force sensor array 1124. In some examples, the second touch sensor array may be an array of capacitive touch sensors. Steady-state force sensors are distinguishable from transient force sensors such as PFEs. Steady-state force sensors provide signals that are responsive to the applied force under steady-state conditions; steady-state force sensors continue to provide the signal as long as the applied force is on. Transient force sensors (e.g., PFEs) provide signals that are responsive to changes in applied force (e.g., change from little or no force to a force applied by a finger during finger touch or finger press). These signals dissipate quite quickly (e.g., in a range of 10 ms to 100 ms, in a range of 1 ms to 10 ms, or less than 1 ms) even if the applied force continues to be on. Some examples of steady-state force sensors are strain gauges and parallel-plate force sensors. The PUT array 1102 and the optional secondary touch sensor array 1104 may be regarded as the touch-sensing portion 1110 of system 1100. The PFE array 1122 and the steady-state force sensor array 1124 may be regarded as the force-sensing portion 1120 of system 1100. These sensor arrays (1102, 1104, 1122, 1124) are coupled to the signal processor 1130. The signal and data flow between the sensor arrays may be in monodirectional (e.g., signals representing measurement data from sensor array to the signal processor) or bidirectional (e.g., signals representing measurement data from sensor array to the signal processor, and signals for driving the transducers from the signal processor to the transducer (sensor) array). For example, the voltage signals for driving the transmitting-type PUTs may be generated and amplified at the signal processor 1130 and transmitted to the PUT array 1102.

As explained herein, each sensor array may be employed to obtain centroid data. Multiple sets of centroid data may be combined to obtain combined centroid data which may indicate touch position with greater accuracy (compared to determining the touch position from an individual centroid data). In the example shown in FIG. 11A, PUT centroid data and PFE centroid data may be obtained from the PUT array and PFE array, respectively. In implementations in which there is a second touch sensor array 1104, a second touch sensor centroid data may be obtained from the output of the second touch sensor array 1104. In implementations in which there is a steady-state force sensor array 1124), a steady-state force sensor centroid data may be obtained from the output of the steady-state force sensor array. These sets of centroid data may be combined to obtain a combined centroid data. Herein, centroid data that get combined to obtain combined centroid data are sometimes referred to as applicable centroid data. These centroid data may be obtained and combined by the signal processor 1130.

In some implementations of FIG. 11A, a single second touch sensor 1105 may be provided instead of a second touch sensor array 1104. In such implementations, the second touch sensor 1105 would not generate centroid data. Accordingly, the output from the second touch sensor 1105 would not be used as an input to obtaining a combined centroid data. However, the output from the second touch sensor 1105 may be useful, in combination with outputs from the other sensor arrays (e.g., 1102, 1122, 1124), in determining whether a touch event has occurred, with a greater confidence and/or greater rejection of false positives. In some implementations of FIG. 11A, a single steady-state force sensor 1125 may be provided instead of a steady-state force sensor array 1124. In such implementations, the steady-state force sensor 1125 would not generate centroid data. Accordingly, the output from the steady-state force sensor 1125 would not be used as an input to obtaining a combined centroid data. However, the output from the steady-state force sensor 1125 may be useful, in combination with outputs from the other sensors (e.g., 1102, 1122, 1124), in determining whether a touch event has occurred, with a greater confidence and/or greater rejection of false positives.

In some implementations of FIG. 11A, the touch-sensing system further comprises a haptic module 1140. The haptic module comprises a haptic controller 1142 and a haptic actuator 1144. The signal processor 1130 may generate haptic feedback commands (e.g., in response to a finger touch input at the cover stack, as sensed by any one or more of the sensors 1102, 1104, 1105, 1122, 1124, and 1125). In addition, the signal processor 1130 may generate haptic feedback commands in accordance with other inputs (e.g., inputs from an external system). The haptic controller 1142 drives the haptic actuator in accordance with the haptic feedback commands from the signal processor. The haptic actuator may be any suitable actuator know in the art such as an eccentric rotating mass (ERM) motor or a linear resonant actuator (LRA). Additionally, a voice coil motor may also be employed as a haptic actuator. The haptic actuator is preferably configured to be vibrationally coupled to the cover stack where the vibration may be felt by a finger.

FIG. 11B is a schematic diagram illustrating certain signal-generating and signal-processing aspects of a touch-sensing system 1150 in accordance with some embodiments. Touch-sensing system 1150 is similar to touch-sensing system 1100 (FIG. 11A) in some respects, e.g., PUT array 1102, signal processor 1130, haptic module 1140, haptic controller 1142, and haptic actuator 1144. The touch-sensing portion 1110 includes a PUT array 1102 and may include a second touch sensor array 1104 or a second touch sensor 1105, as described with reference to FIG. 11A. Touch-sensing system 1150 includes a force-sensing portion 1160, which includes a PFE 1162 and may include a steady-state force sensor 1125. Accordingly, the force-sensing portion 1160 includes only single sensors (single PFE, and optional single steady state-force sensor). No centroid data are obtained from the force-sensing portion 1160. On the other hand, centroid data may be obtained from the touch-sensing portion 1110. In implementations in which a PUT array 1102 and a second touch sensor array 1104 are present, PUT centroid data and second touch sensor centroid data may be obtained, and combined centroid data may be obtained by combining the PUT centroid data and the second touch sensor centroid data.

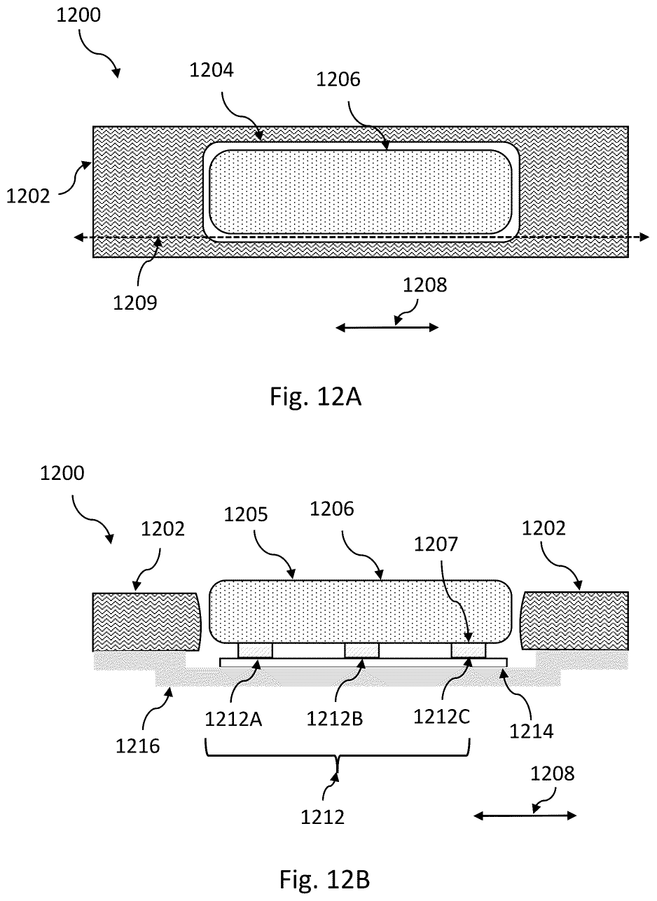

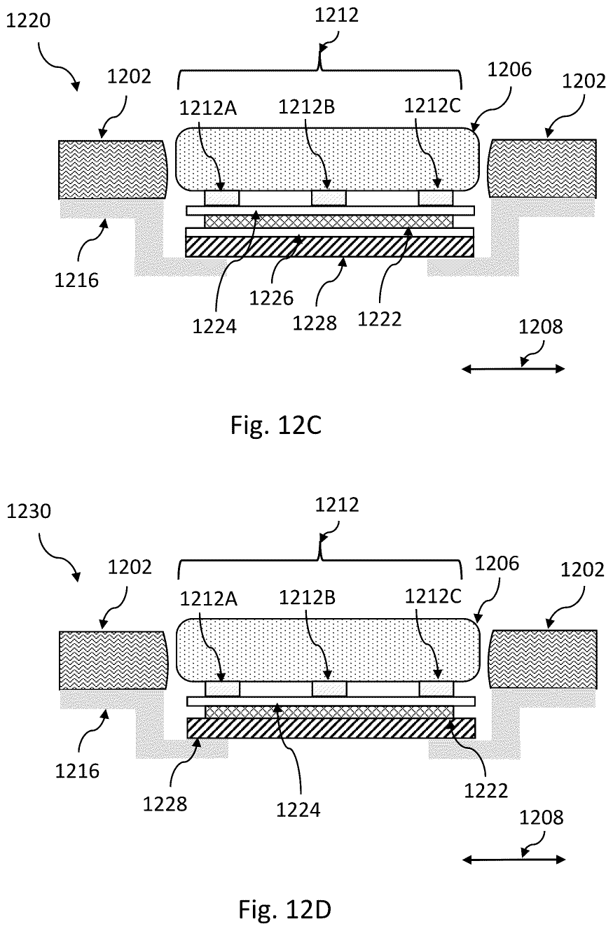

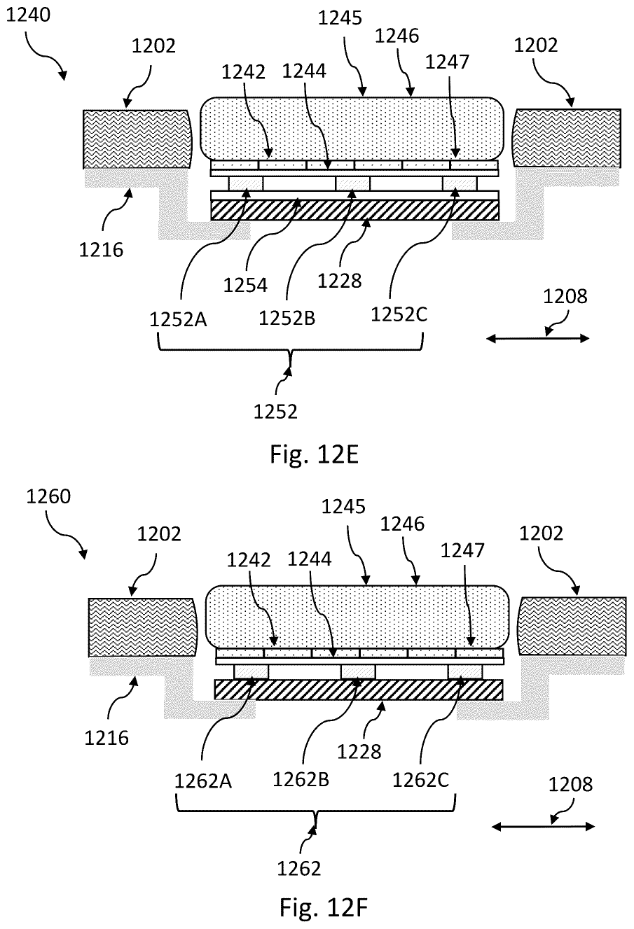

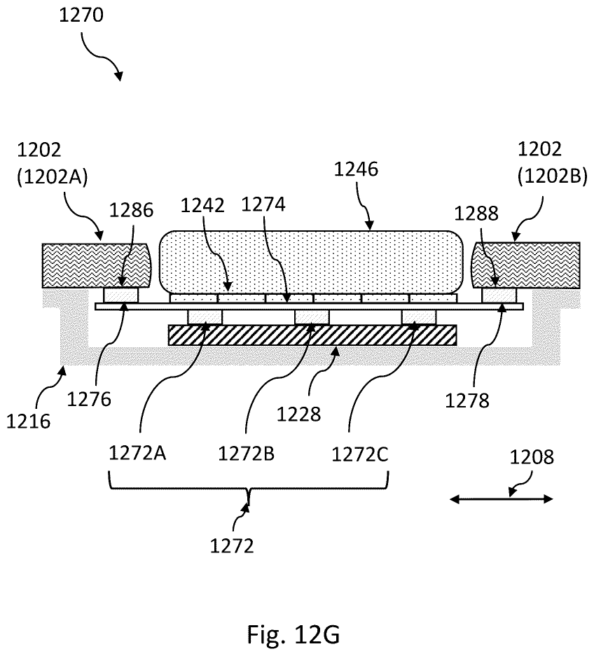

FIG. 12A is a schematic plan view of a touch-sensing system 1200 implemented as a button-type sensing system. Touch-sensing system 1200 includes a frame 1202 surrounding a button 1206 which can be pressed and released by a finger. If needed, a small gap (open space) 1204 may be provided between frame 1202 and button 1206. A cross section is taken across touch-sensing system 1200 along line 1209 and is shown in FIG. 12B. Button 1206 is not a mechanical button in accordance with conventional technologies; instead, button 1206 is configured as a cover stack for an underlying array (1212) of piezoelectric capacitors (1212A, 1212B, and 1212C). The button (cover stack) 1206 may be an electrical insulator (e.g., plastic, ceramic) or an electrical conductor (e.g., metal). The frame (1202) may be an electrical insulator (e.g., plastic, ceramic) or an electrical conductor (e.g., metal). Piezoelectric capacitor array 1212 is mechanically coupled to cover stack (button) 1206. In some examples, piezoelectric capacitor array 1212 is adhered to the button via an adhesive (not shown). In the example shown, an adhesive may be applied between the top surfaces of the piezoelectric capacitors and the bottom surface of the cover stack (button) 1206. Piezoelectric capacitors 1212 are mounted to and electrically connected to a circuit board substrate 1214 (e.g., printed circuit board (PCB), flexible printed circuit board (FPC)). In the example shown, the bottom surfaces of the piezoelectric capacitors 1212 are mounted to the circuit board substrate 1214. In turn, circuit board substrate 1214 is mounted to a bracket (mechanical support) 1216, which is attached to the peripheral frame 1202. The piezoelectric capacitor array 1212 extends along a longitudinal direction 1208. The piezoelectric capacitor array 1212 overlies the underlying circuit board substrate 1214.

FIGS. 12C and 12D are schematic cross-sectional views of touch-sensing systems 1220 and 1230, respectively, implemented as button-type sensing systems. Touch-sensing systems 1220 and 1230 are similar to touch-sensing system 1200 in some respects (e.g., the systems comprise a frame 1202, a button (cover stack) 1206, and an array of piezoelectric capacitors 1212 extending along a longitudinal direction 1208). Touch-sensing systems 1220 and 1230 additionally comprise a capacitive-type force sensor and a haptic module 1228. A haptic module includes a haptic controller and a haptic actuator. The haptic actuator is mechanically connected, via other components, to the cover stack (and to the frame), such that the vibrations emitted from the haptic actuator may be felt by a finger touching the cover stack. Such a mechanical connection between the haptic actuator and the cover stack may be referred to as “vibrational coupling.” Note that a haptic module also includes a haptic controller although the haptic controller may be located outside of the haptic module housing (e.g., mounted to a circuit board outside of the haptic module housing). The haptic controller is configured to drive the haptic actuator in accordance with haptic feedback commands from the signal processor. For example, such haptic feedback commands may be generated (e.g., by the signal processor) in response to inputs entered at the touch-sensing system, such as touch inputs or other command inputs. In some implementations, the haptic feedback commands may be generated by an external system (e.g., a processor outside of the touch-sensing system).

A capacitive-type force sensor is a steady-state force sensor that exhibits a capacitance in accordance with an applied force. In some implementations, an elastic material (e.g., a silicone rubber, a polyurethane elastomer, polyimide, or other elastic polymer) is interposed as a capacitor dielectric between two conductive plates. Since the conductive plates are approximately parallel, the capacitive-type force sensor is sometimes referred to as a parallel-plate force sensor. For a capacitor, the capacitance C is given by εA/d, wherein ε is a permeability of the capacitor dielectric (e.g., elastic material), A is the area of the capacitor, and d is the distance between the capacitor plates. When a force F is applied to a capacitive-type force sensor, resulting in a decrease in the distance d between the capacitor plates, the change in capacitance ΔC is approximately proportional to F. In the example shown, the applied force may arise from a finger press on a cover stack 1206, which is transmitted to the capacitive-type force sensor. Touch-sensing systems 1220 and 1230 include a capacitor dielectric (a thin elastic material) 1222. In the example of touch-sensing system 1220, the piezoelectric capacitors (1212A, 1212B, 1212C) are mounted to a (first) circuit board substrate (e.g., printed circuit board (PCB)) 1224, a top electrode of the capacitive-type force sensor may be a metal layer on the circuit board substrate 1224 (e.g., metal layer on a bottom surface of the circuit board substrate 1224), and a bottom electrode of the capacitive-type force sensor may be a metal layer on another (second) circuit board substrate (e.g., printed circuit board (PCB)) 1226 (e.g., metal layer on a top surface of the circuit board substrate 1226). The (second) circuit board substrate 1226 is mounted to (attached to) an external housing of a haptic module 1228. For touch-sensing systems 1220 and 1230, haptic module 1228 is mounted (attached) to the bracket 1216 and is configured to mechanically support the capacitive-type force sensor. The piezoelectric capacitor array 1212 overlies the underlying capacitive force sensor, which in turn overlies the underlying haptic module 1228. In the example of touch-sensing system 1230, the piezoelectric capacitors (1212A, 1212B, 1212C) are mounted to a (first) circuit board substrate (e.g., printed circuit board (PCB)) 1224, and a top electrode of the capacitive-type force sensor may be a metal layer on the circuit board substrate 1224 (e.g., metal layer on a bottom surface of the circuit board substrate 1224). In the example of touch-sensing system 1230, the (second) circuit board substrate is omitted. Instead, a portion of an external housing of the haptic module 1228 is configured as a bottom electrode of the capacitive-type force sensor. In such implementations, the external housing may be an electrical conductor (e.g., metallic).

FIGS. 12E and 12F are schematic cross-sectional views of touch-sensing systems 1240 and 1260, respectively, implemented as button-type sensing systems. Touch-sensing systems 1240 and 1260 are similar to touch-sensing systems 1220 and 1230 in some respects (e.g., the systems comprise a frame 1202, bracket (mechanical support) 1216, haptic module 1228). Touch-sensing systems 1240 and 1260 include a cover stack (button) 1246 which may be an electrical insulator (e.g., plastic, ceramic). Button 1246 overlies an underlying array of capacitive touch sensor electrodes 1242. In touch-sensing system 1240, the capacitive touch sensor electrodes 1242 are formed on a circuit board substrate 1244 (e.g., printed circuit board (PCB) or a flexible printed circuit board (FPC)). Because of the presence of array of capacitive touch sensor electrodes 1242, it may be preferable to avoid the use of an electrical conductor (e.g., metal) as the button 1246. Touch-sensing system 1240 includes an array 1252 of piezoelectric capacitors (1252A, 1252B, and 1252C). Touch-sensing system 1260 includes an array 1262 of piezoelectric capacitors (1262A, 1262B, and 1262C). In touch-sensing system 1240, the piezoelectric capacitor array 1252 is mounted to and electrically connected to another (second) circuit board substrate (e.g., printed circuit board (PCB) or a flexible printed circuit board (FPC)) 1254. Second circuit board substrate 1254 is mounted to (attached to) an external housing of the haptic module 1228. In touch-sensing system 1260, the piezoelectric capacitor array 1262 is mounted to and electrically connected to the circuit board substrate 1244 on which the capacitive touch sensor electrodes 1242 are formed. In the example shown in FIG. 12F, the touch sensor electrodes 1242 are formed on a top surface of the circuit board substrate 1244 and the piezoelectric capacitor array 1262 is electrically connected to a bottom surface of the circuit board substrate 1244. In touch-sensing systems 1240 and 1260, the capacitive touch sensor electrodes 1242 overlie the underlying piezoelectric capacitor array (1252 or 1262), which in turn overlies the underlying haptic module 1228. When touch-sensing systems 1240 and 1260 are compared, the “vertical” orientation of the piezoelectric capacitor array are reversed: in 1240, the piezoelectric capacitors are electrically connected to a circuit board substrate located below it (1254) while in 1260, the piezoelectric capacitors are electrically connected to a circuit board substrate located above it (1244) which is shared with the touch sensor electrodes.

The touch-sensing systems illustrated in FIGS. 12B through 12F show configurations in which the piezoelectric capacitors are mechanically coupled to the cover stack at the inner interface of the cover stack. For the example shown in FIG. 12B, the cover stack (button) 1206 has an outer surface 1205 that can be touched by a finger. The cover stack has a longitudinal direction (1208) along which the finger can touch and slide on the outer surface 1205. In some implementations, the button 1206 may protrude from the peripheral frame 1202, to permit a finger to touch and slide along the outer surface 1205. The cover stack (button) 1206 also has an inner interface 1207 at which the piezoelectric capacitors (1212A, 121212B, 1212C) are mechanically coupled. The piezoelectric capacitors may be provided as as individually packaged elements, or the entire array 1212 may be in the form of a packaged device. In either case, the mechanical coupling may be optimized by applying an adhesive layer (as described elsewhere herein) between the piezoelectric capacitors and the cover stack (button) 1206. For the examples shown in FIGS. 12E and 12F, the button 1246 has an outer surface 1245 that can be touched by a finger, and an inner interface 1247 at which the piezoelectric capacitors (1252A, 1252B, 1252C; or 1262A, 1262B, 1262C) are mechanically coupled. A circuit board substrate 1244, including the touch sensor electrodes 1242 formed thereon, are located in an intervening space between the piezoelectric capacitors and the cover stack (button) 1246. The mechanical coupling may be optimized by applying an adhesive layer (as described elsewhere herein) between a top surface of the circuit board substrate 1242 (e.g., the touch sensor electrodes 1242) and the inner interface 1247 of the cover stack (button) 1246. In addition, for the example shown in FIG. 12E, the mechanical coupling may be optimized by applying an adhesive layer (as described elsewhere herein) between a bottom surface of the circuit board substrate 1242 and the piezoelectric capacitors (1252A, 1252B, 1252C).

FIG. 12G is a schematic cross-sectional view of touch-sensing system 1270 implemented as a button-type sensing system. Touch-sensing system 1270 is similar to touch-sensing system 1260 in some respects (e.g., the systems comprise a frame 1202, bracket (mechanical support) 1216, haptic module 1228, button 1246, capacitive touch sensor electrodes 1242). Button 1246 overlies an underlying array of capacitive touch sensor electrodes 1242. The capacitive touch sensor electrodes 1242 are formed on a circuit board substrate 1274 (e.g., printed circuit board (PCB) or a flexible printed circuit board (FPC)). An array 1272 of piezoelectric capacitors (e.g., 1272A, 1272B, 1272C) is mounted to and electrically connected to the circuit board substrate 1274. In the example shown in FIG. 12G, the touch sensor electrodes 1242 are formed on a top surface of the circuit board substrate 1274 and the piezoelectric capacitor array 1272 is electrically connected to a bottom surface of the circuit board substrate 1274. Touch-sensing system 1270 additionally includes piezoelectric capacitors 1276, 1278 that are mechanically coupled to the left portion 1202A and right portion 1202B of the frame 1202. An adhesive layer may be applied between an underside 1286 of a left frame portion 1202A and a top surface of the piezoelectric capacitor 1276 to optimize mechanical coupling to piezoelectric capacitor 1276. Similarly, an adhesive layer may be applied between an underside 1288 of the right frame portion 1202B and a top surface of the piezoelectric capacitor 1278 to optimize mechanical coupling to piezoelectric capacitor 1278. The piezoelectric capacitors 1276, 1278 may be considered to be an array of piezoelectric capacitors extending along the longitudinal direction 1208. Piezoelectric capacitors 1276, 1278 may be employed as PUTs (e.g., transmitting-type PUTs, receiving-type PUTs) and/or PFEs, as described herein. Moreover, more than one piezoelectric capacitor may be mechanically coupled to the left frame portion 1202A and more than one piezoelectric capacitor may be mechanically coupled to the right frame portion 1202B in other implementations. The left frame portion 1202A is configured as a cover stack for piezoelectric capacitor 1276 and the right frame portion 1202B is configured as a cover stack for piezoelectric capacitor 1278. Piezoelectric capacitors 1276, 1278 are mounted to and electrically connected to circuit board substrate 1274 on its top surface (e.g., the top surface facing outwards towards the frame 1202 and the button 1246; the surface on which the capacitive touch sensor electrodes 1242 are formed). The piezoelectric capacitors (1272A, 1272B, 1272C) that are mounted to and electrically connected to circuit board substrate on its bottom surface are mechanically coupled to the button 1246 instead of the frame 1202. Touch-sensing system 1270 may afford the following advantages over touch-sensing system 1260 (or 1240): (1) the touch-sensitive region extends beyond the button 1246 to adjacent areas (e.g., left frame portion 1202A, right frame portion 1202B) (the touch-sensitive region is larger); (2) the use of different combinations of cover stacks (e.g., the frame 1202 may be an electrical insulator or an electrical conductor, the button 1246 may be an electrical insulator) and sensors (e.g., capacitive touch sensor electrodes 1242 and piezoelectric capacitors 1272A, 1272B, 1272C are sensitive to touch and/or press at the button 1246; piezoelectric capacitors 1276, 1278 are sensitive to touch and/or press at frame 1202) improves rejection of false-positives.

In FIGS. 12B-12G, three piezoelectric capacitors are shown mechanically coupled to each respective button. However, the number of piezoelectric capacitors is not limited to three. In some implementations, the array of piezoelectric capacitors includes at least two piezoelectric capacitors. The array includes at least two piezoelectric capacitors configured as piezoelectric ultrasonic transducers (PUTs) and at least two piezoelectric capacitors configured as piezoelectric force-measuring elements (PFEs). Each of the PUTs is configured as a transmitting-type PUT and/or a receiving-type PUT. The number of receiving-type PUTs is two or more. The PUTs constitute a PUT array and the PFEs constitute a PFE array. In some implementations, all of the piezoelectric capacitors may be configured as PUTs, constituting a PUT array, and also configured as PFEs, constituting a PFE array. For example, each of the piezoelectric capacitors functions as a PFE at some times, as a transmitting-type PUT at other times, and as a receiving-type PUT at yet other times. In other implementations, some (e.g., two or more, but not all) of the piezoelectric capacitors are configured as PUTs, constituting a PUT array, and some (e.g., two or more, but not all) of the piezoelectric capacitors are configured as PFEs, constituting a PFE array. In yet other implementations, some (e.g., two or more, but not all) of the piezoelectric capacitors are configured as PUTs, constituting a PUT array, and one of the piezoelectric capacitors is configured as a PFE (since there is only a single PFE, there is no PFE array). While not explicitly shown, each of the touch-sensing systems of FIGS. 12B-12G includes a suitable signal processor that is coupled to the respective transducers. In the touch-sensing systems of FIGS. 12A-12G, only one button is shown. However, in some implementations, a touch-sensing system may comprise multiple buttons. In some cases, each of the multiple buttons may be coupled to a respective piezoelectric capacitor array (e.g., PUT arrays, PFE arrays) and, optionally, a respective additional sensor array. In other cases, each of the multiple buttons may be coupled to a respective portion of a piezoelectric capacitor array (e.g., PUT arrays, PFE arrays) and, optionally, a respective portion of an additional sensor array. Since the buttons are not mechanical buttons according to conventional technologies, it would not be necessary to physically separate a cover stack into multiple buttons. For example, a protruded (or recessed) line between adjacent buttons would be sufficient to alert the user that multiple buttons are intended.

In FIG. 12G, the button 1246 is configured as a first cover stack, mechanically coupled to piezoelectric capacitors 1272A, 1272B, 1272C and the peripheral frame 1202 (surrounding the button) configured as a second cover stack mechanically coupled to piezoelectric capacitors 1276, 1278. While one piezoelectric capacitor (1276) is shown located to the left of button 1246 and one piezoelectric capacitor (1278) is shown located to the right of button 1246, more than one piezoelectric capacitor may be provided to the left, to the right, and/or at another location mechanically coupled to the frame 1202. In the example shown, the piezoelectric capacitors 1276, 1278 constitute an array of piezoelectric capacitors extending along the longitudinal direction 1208.

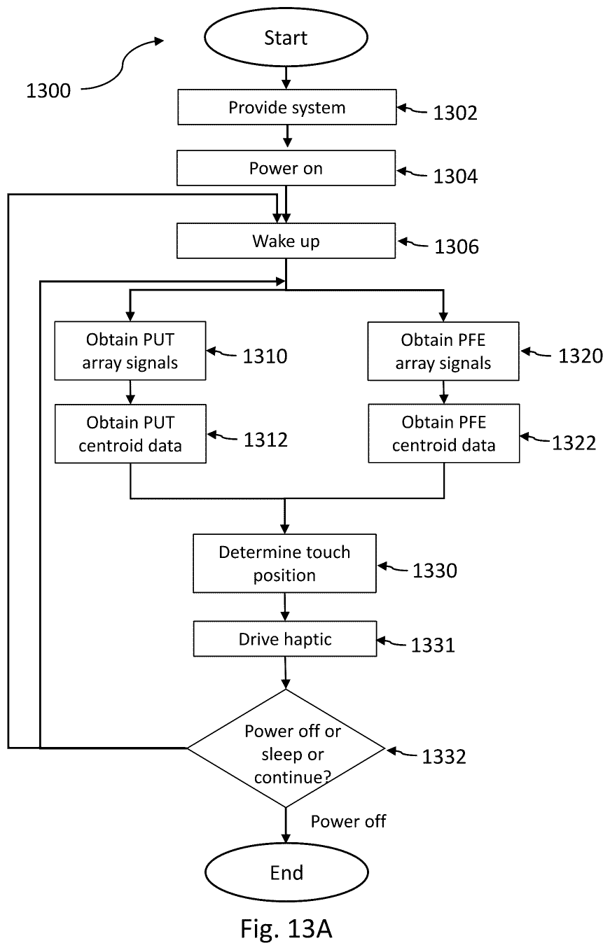

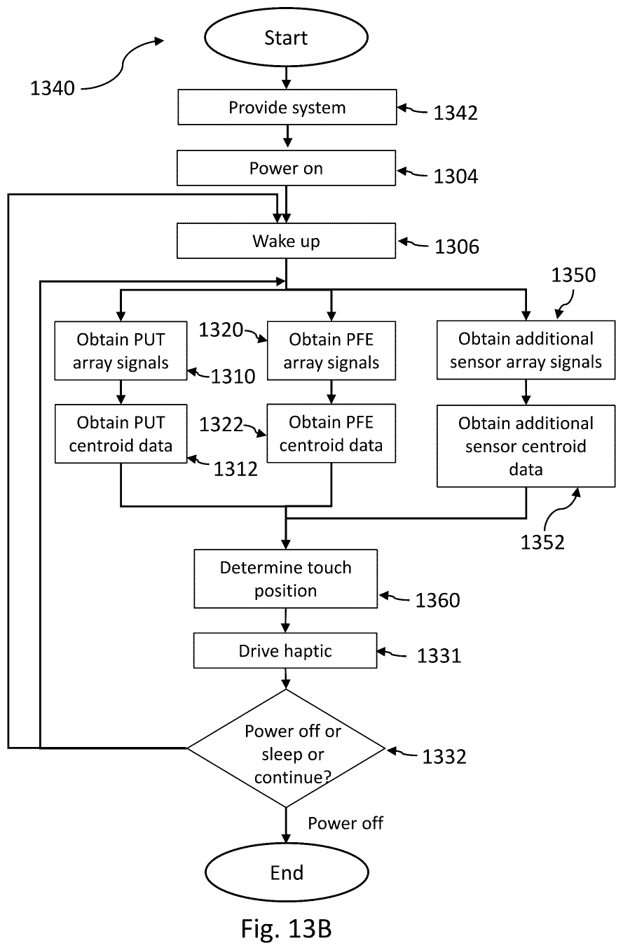

FIG. 13A is a flow diagram of process 1300 of sensing touch according to some implementations. Process 1300 includes stages 1302, 1304, 1306, 1310, 1312, 1320, 1322, 1330, 1331, and 1332. Stage 1302 includes providing a touch-sensing system (e.g., 100 of FIGS. 1B, 141 of FIGS. 1C, 1100 of FIGS. 11A, 1200 of FIGS. 12A and 12B, 1220 of FIGS. 12C, 1230 of FIGS. 12D, 1240 of FIGS. 12E, 1260 of FIGS. 12F, 1270 of FIG. 12G). Stage 1304 includes turning on the touch-sensing system (e.g., supplying electrical power to the system, initializing the system). Upon completion of stage 1304, the touch-sensing system may be in a lower-power mode (e.g., the system may be in either a higher-power mode or a lower-power mode). At stage 1306, the touch-sensing system transitions from the lower-power mode to a higher-power mode, in which the sensors of the touch-sensing system are active. For example, this transition to the higher-power mode may be triggered by a signal (e.g., “wake-up signal”) from an external source. For example, this transition to the higher-power mode may be triggered by a signal (e.g., “wake-up signal”) from one or more of the sensors of the touch-sensing system that stays on in the lower-power mode. After the sensors have been activated, there are left and right branches in the process 1300 relating to operation of the PUTs and the PFEs, respectively. The left and right branches may be carried out concurrently or sequentially. The left branch includes stages 1310 and 1312. Stage 1310 may include: (1) transmitting, by the transmitting-type PUTs, ultrasound waves towards the cover stack in a predetermined frequency range, with the ultrasound waves propagating along a normal direction approximately normal to a plane of the one or more piezoelectric members; (2) receiving, by the receiving-type PUTs, the ultrasound waves from the cover stack in the predetermined frequency range; and (3) generating the PUT array signals in accordance with the ultrasound waves received at the receiving-type PUTs. For example, the PUT array signals are transmitted from the PUTs (PUT array) to the signal processor. For example, the PUT array signals may undergo amplification, analog-to-digital conversion, and any other suitable signal conditioning (e.g., high-pass filtering, subtraction of noise), at the signal processor (and/or elsewhere). At stage 1312, PUT centroid data are obtained from the PUT array signals. For example, the signal processor calculates the PUT centroid data from the PUT array signals. The right branch includes stages 1320 and 1322. Stage 1320 may include: obtaining PFE array signals from voltage signals generated at the PFEs in response to a low-frequency deformation of the cover stack. Herein, the term “low-frequency deformation” is used to refer to deformation is induced by touch excitation which is not repetitive (repetition rate is effectively 0 Hz) or is repetitive having a repetition rate of 100 Hz or less, or 10 Hz or less. These low frequencies are distinguishable from ultrasound waves (e.g., the ultrasound waves transmitted and/or received by PUTs), which typically have frequencies of 100 kHz to 50 MHz. For example, the PFE array signals are transmitted from the PFEs (PFE array) to the signal processor. For example, the PFE array signals may undergo amplification, analog-to-digital conversion, and any other suitable signal conditioning (e.g., high-pass filtering, subtraction of noise), at the signal processor (and/or elsewhere). At stage 1322, PFE centroid data are obtained from the PFE array signals. For example, the signal processor calculates the PFE centroid data from the PFE array signals.

Stage 1330 includes determining an estimated touch position on the cover stack by combining the applicable centroid data (in this case, the applicable centroid data are the PUT centroid data and the PFE centroid data). The PUT centroid data and the PFE centroid data are characterized by a PUT signal-to-noise ratio (PUT SNR) and a PFE signal-to-noise ratio (PFE SNR), respectively. The PUT SNR and the PFE SNR are time-varying and may be affected not only by a finger touch (including finger press) but by other factors affecting the cover stack (e.g., objects contacting the cover stack, temperature changes). For example, when an outer surface of the cover stack is covered by foreign materials (e.g., water, sweat, other liquids, ice, snow, foods) the PUT SNR may be quite low. However, if there is a finger touch (including finger press) at those times when the PUT SNR is quite low, the PFE SNR may be quite high, and the touch position may be estimated primarily from the PFE centroid data. For example, when there is a finger touch, but it is a light touch (e.g., relatively small force exerted at the cover stack), the PFE SNR may be quite low (in this case, since there is a light finger touch, the PUT SNR may be sufficiently high). If the PUT SNR is sufficiently high at those times when the PFE SNR is quite low, the touch position may be estimated primarily from the PUT centroid data. The PUT centroid data may be apportioned a PUT fractional weight w(PUT) and the PFE centroid data may be apportioned a PFE fractional weight w(PFE) in combining (e.g., adding) the PUT and PFE centroid data to obtain an estimated touch position. The PUT fractional weight w(PUT) and the PFE fractional weight w(PFE) may be time-varying and may vary in accordance with temporal changes to the PUT SNR and/or temporal changes to the PFE SNR.

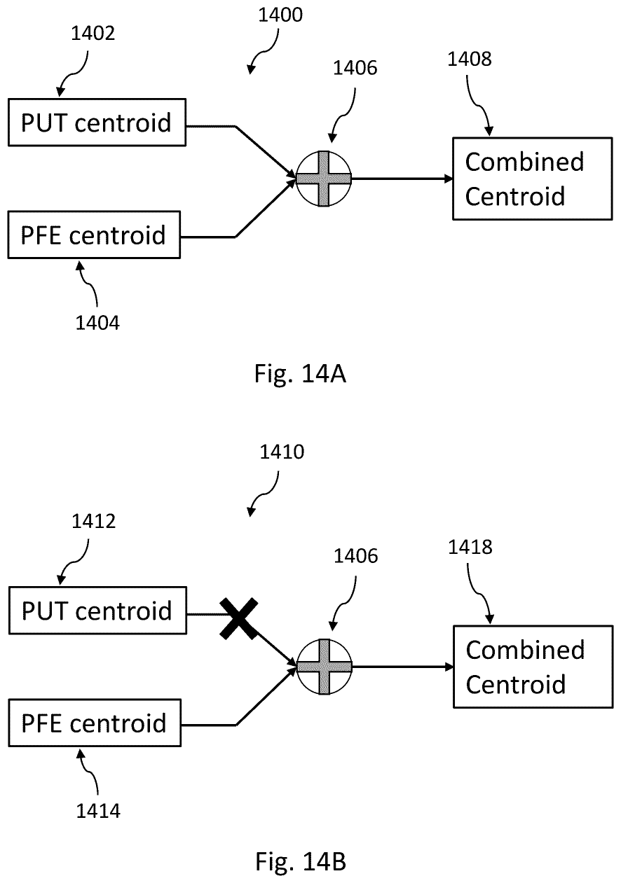

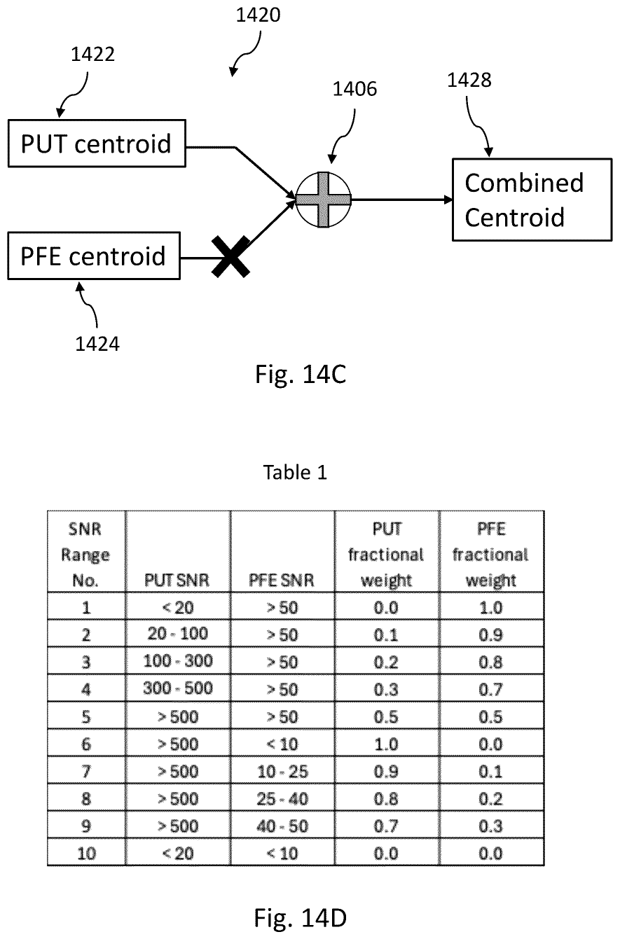

FIGS. 14A, 14B, and 14C schematically illustrate the combination of PUT centroid data and PFE centroid data in accordance with respective fractional weights of the PUT centroid data and the PFE centroid data. FIG. 14A schematically illustrates a calculation process 1400 in which PUT centroid data 1402 and PFE centroid data 1404 are combined (e.g., added) in a combination operation 1406 to obtain combined centroid data (e.g., estimated touch position) 1408. The calculation process 1400 may be carried out by the signal processor. In the example shown, the PUT centroid data and the PFE centroid data contribute to the combined centroid data. FIG. 14B schematically illustrates a calculation process 1410 to obtain combined centroid data 1418. In the example shown, PUT centroid data 1412 does not contribute, and PFE centroid data 1414 does contribute, to the combined centroid data 1418. For example, this occurs when the PUT SNR is lower than a certain PUT SNR threshold and the PFE SNR is higher than a certain PFE SNR threshold. For example, the PUT SNR may be lower than a certain PUT SNR threshold if the cover stack is covered by foreign materials. FIG. 14C schematically illustrates a calculation process 1420 to obtain combined centroid data 1428. In the example shown, PUT centroid data 1422 does contribute, and PFE centroid data 1424 does not contribute, to the combined centroid data 1428. For example, this occurs when the PFE SNR is lower than a certain PFE SNR threshold and the PUT SNR is higher than a certain PUT SNR threshold. For example, the PFE SNR may be lower than a certain threshold if there is a finger touch, but it is a light touch.

FIG. 14D (Table 1) shows the PUT fractional weights and the PFE fractional weights for respective ranges of PUT SNR values and PFE SNR values, for an example implementation. The PUT fractional weight and the PFE fractional weight are apportioned to the PUT centroid data and the PFE centroid data, respectively, in calculating combined centroid data. In the example shown, the PUT and the PFE fractional weights sum to 1. In other implementations, the PUT and PFE fractional weights may sum to less than 1 (e.g., if there is additional centroid data to be considered, obtained from an additional sensor device). When the PUT SNR is less than 20, the PUT SNR is considered to be low and the PUT centroid data are disregarded in the combined centroid data calculation (PUT fractional weight is 0). When the PUT SNR is greater than 500, the PUT SNR is considered to be high and the PUT centroid data are apportioned a large fractional weight. When the PFE SNR is less than 10, the PFE SNR is considered to be low and the PFE centroid data are disregarded in the combined centroid data calculation (PFE fractional weight is 0). When the PFE SNR is greater than 50, the PFE SNR is considered to be high and the PFE centroid data are apportioned a large fractional weight. Accordingly, for SNR Range No. 1, the PUT SNR is low, the PFE SNR is high, the PUT fractional weight is 0.0, and the PFE fractional weight is 1.0. This situation is illustrated in FIG. 14B. For SNR Range No. 5, the PUT SNR is high, the PFE SNR is high, the PUT fractional weight is 0.5, and the PFE fractional weight is 0.5. This situation is illustrated in FIG. 14A. For SNR Range No. 6, the PUT SNR is high, the PFE SNR is low, the PUT fractional weight is 1.0, and the PFE fractional weight is 0.0. This situation is illustrated in FIG. 14C. For SNR Range Nos. 2, 3, and 4, the PFE SNR values are high but the PUT SNR values are moderate (e.g., higher than the low range of <20 and lower than the high range of >500). Accordingly, the PUT fractional weights are lower than PFE fractional weights but are not zero. The PUT fractional weights vary between 0.1 and 0.3 and the PFE fractional weights vary between 0.9 and 0.7. For SNR Range Nos. 7, 8, and 9, the PUT SNR values are high but the PFE SNR values are moderate (e.g., higher than the low range of <10 and lower than the high range of >50). Accordingly, the PFE fractional weights are lower than PUT fractional weights but are not zero. The PFE fractional weights vary between 0.1 and 0.3 and the PUT fractional weights vary between 0.9 and 0.7. In some implementations, when the PUT SNR is greater than a PUT SNR threshold (e.g., 500, above which the PUT SNR is considered high) and the PFE SNR is greater than a PFE SNR threshold (e.g., 50, above which the PFE SNR is considered high), a ratio of the PUT fractional weight to the PFE fractional weight may be in a range of 40:60 to 60:40 (e.g., in a range of 45:55 to 55:45, in a range of 48:52 to 52:48, in a range of 49:51 to 51:49, in a range of 40:60 to 45:55, or in a range of 55:45 to 60:40). In some implementations, when the PUT SNR is not greater than a PUT SNR threshold (e.g., 500) (e.g., in ranges such as <20, 20-100, 100-300,300-500) and the PFE SNR is greater than a PFE SNR threshold (e.g., 50), a ratio of the PUT fractional weight to the PFE fractional weight may be in a range of 0:100 to 35:65 (e.g., in a range of 0:100 to 10:90, in a range of 10:90 to 20:80, in a range of 20:80 to 30:70, or in a range of 30:70 to 35:65). In some implementations, when the PUT SNR is greater than a PUT SNR threshold (e.g., 500) and the PFE SNR is not greater than a PFE SNR threshold (e.g., 500) (e.g., in ranges such as <10, 10-25, 25-40, 40-50), a ratio of the PUT fractional weight to the PFE fractional weight may be in a range of 100:0 to 65:35 (e.g., in a range of 100:0 to 90:10, in a range of 90:80 to 80:20, in a range of 80:20 to 70:30, or in a range of 70:30 to 65:35). For SNR Ranges Nos. 1-9, a determination may be made (e.g., by the signal processor) that a touch event has occurred on the cover stack (e.g., at the outer surface of the cover stack). Stage 1330 includes determining (e.g., by the signal processor) whether a touch event on the cover stack (e.g., at the outer surface of the cover stack) has occurred.

According to the examples illustrated for SNR Ranges 1-9, the touch position is estimated if at least one of the centroid data has a high SNR (e.g., >500 for PUT SNR and >50 for PFE SNR). For SNR Range No. 10, the PUT SNR and the PFE SNR are low (<20 and <10, respectively), and the PUT and PFE fractional weights are zero. Accordingly, the PUT centroid data and the PFE centroid data are disregarded. In the absence of other data, the touch position may not be estimated. A determination may be made (e.g., by the signal processor) that no touch event has occurred on the cover stack (e.g., at the outer surface of the cover stack). In addition, there are PUT SNR ranges and PFE SNR ranges, in combination, that are not listed in Table 1. These are ranges for which the PUT SNR values are moderate (e.g., 20-500, including sub-ranges such as 20-100, 100-300, 300-500) and the PFE SNR values are moderate (e.g., 10-50, including sub-ranges such as 10-25, 25-40, 40-50). In some implementations, the available data may be insufficient to determine whether a touch event has occurred. In some other implementations, the available data may be sufficient, at least in some cases, to determine whether a touch event has occurred and estimate a touch position. In such cases, a suitable combination of PUT and PFE fractional weights may be apportioned. Consider an example in which the PUT SNR is in a range of 100-300 (for SNR Range No. 3, PUT fractional weight is 0.2) and the PFE SNR is in a range of 40-50 (PFE fractional weight of 0.3 from SNR Range No. 9). In this example, a ratio of the PUT fractional weight to the PFE fractional weight may be 40:60. Herein, the term “determine an estimated touch position” also includes the possibilities of returning no estimated touch position as a result of, for example, (1) determining that no touch event has occurred or (2) determining that there is insufficient data to determine whether a touch event has occurred.

In some implementations, stage 1331 may be optional. Stage 1331 may be carried out in touch-sensing systems that comprise a haptic module, in which the haptic module comprises a haptic actuator and a haptic controller, with the haptic actuator being vibrationally coupled to the cover stack. Stage 1331 includes driving, by the haptic controller, the haptic actuator in accordance with haptic feedback commands from the signal processor or another suitable source of haptic feedback commands (e.g., a processor outside of the touch-sensing system).

At stage 1332, three or more options are possible. A first option is that the touch-sensing system powers off. For example, this may occur if the power supply is turned off or a battery power source is depleted. A second option is that the touch-sensing system goes into a lower-power mode (e.g., the touch sensor is inactive in the lower-power mode) when at least one condition is met, such as if no touch is detected for a certain time period or upon completion of a predetermined time period. Otherwise, a third option is that stages 1310, 1312, 1320, 1322, and 1330 (and optionally, 1331) are repeated for additional time.

FIG. 13B is a flow diagram of process 1340 of sensing touch according to some implementations. Process 1340 includes stages 1342, 1304, 1306, 1310, 1312, 1320, 1322, 1350, 1352, 1360, 1331, and 1332. Process 1340 is similar to process 1300 (FIG. 13A) in some respects (e.g., stages 1304, 1306, 1310, 1312, 1320, 1322, 1331, and 1332 are similar to the respective stages in process 1300). Stage 1342 includes providing a touch-sensing system (e.g., 100 of FIGS. 1B, 141 of FIGS. 1C, 1100 of FIGS. 11A, 1240 of FIGS. 12E, 1260 of FIGS. 12F, 1270 of FIG. 12G). The touch-sensing systems that are provided at stage 1342 includes additional sensors arranged in a third array, in addition to the PUT array and the PFE array. Examples of additional sensors are capacitive touch sensors and steady-state force sensors. Examples of steady-state force sensors are strain gauges and parallel plate force sensors. The term “steady-state force sensors” is employed to distinguish from transient force sensors such as PFEs that exhibit a transient response to changes in applied force. In some aspects, the additional sensors are configured to output additional sensor array signals. In some aspects, the third array extends along the longitudinal direction (e.g., the longitudinal direction along which the PUT and PFE arrays extend). The third array of additional sensors is configured to output additional sensor array signals. Process 1340 includes a PUT array-related left branch (stages 1310, 1312), a PFE array-related middle branch (stages 1320, 1322), and an additional sensor array-related right branch (stages 1350, 1352). These branches may be carried out sequentially or concurrently. The left and middle branches are as described with reference to FIG. 13A. The signal processor is configured to receive the additional sensor array signals. Stage 1350 may include: obtaining the additional sensor array signals. For example, the additional sensor array signals may undergo amplification, analog-to-digital conversion, and any other suitable signal conditioning (e.g., high-pass filtering, subtraction of noise), at the signal processor (and/or elsewhere). At stage 1352, additional sensor centroid data are obtained from the additional sensor array signals. For example, the signal processor calculates the additional sensor centroid data from the additional sensor array signals. The example of FIG. 13B shows only one additional sensor array; in other examples, a touch-sensing system may comprise two or more additional sensor arrays.

Stage 1360 includes determining an estimated touch position on the cover stack by combining the applicable centroid data. In the example shown, the applicable centroid data comprise the PUT centroid data, the PFE centroid data, and the additional sensor centroid data. The PUT centroid data and the PFE centroid data are characterized by respective SNR values, as explained above. The additional sensor centroid data are characterized by an additional sensor signal-to-noise ratio (AS SNR). The AS SNR may be time-varying and may be affected not only by a finger touch (including finger press) but by other factors affecting the cover stack (e.g., objects contacting the cover stack, temperature changes). If each of the centroid data exhibits a high SNR, each of the centroid may be apportioned a relatively high fractional weight (e.g., a fractional weight of about ⅓ to the PUT centroid data, the PFE centroid data, and the additional sensor centroid data, respectively) in combining (e.g., adding) the centroid data to obtain an estimated touch position. If one (or more) of the centroid data exhibits a low SNR, then a relatively low fractional weight may be apportioned to those centroid data and a relatively high fractional weight may be apportioned to the other centroid data that exhibit high SNRs. The PUT fractional weight, the PFE fractional weight, and the AS fractional weight may be time-varying.

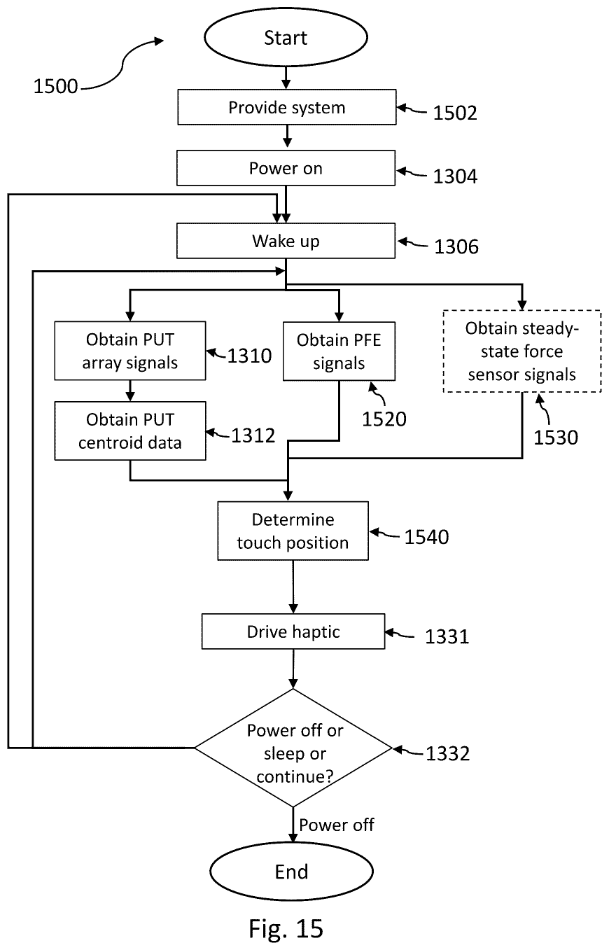

FIG. 15 is a flow diagram of a process 1500 of sensing touch according to some implementations. Process 1500 includes stages 1502, 1304, 1306, 1310, 1312, 1520, 1530, 1540, 1331, and 1332. Process 1500 is similar to process 1300 (FIGS. 13A) and 1340 (FIG. 13B) in some respects (e.g., stages 1304, 1306, 1310, 1312, 1331, and 1332 are similar to the respective stages in processes 1300 and 1340). Stage 1502 includes providing a touch-sensing system (e.g., 100 of FIGS. 1B, 141 of FIGS. 1C, 1150 of FIGS. 11B, 1200 of FIGS. 12A and 12B, 1220 of FIGS. 12C, 1230 of FIGS. 12D, 1240 of FIGS. 12E, 1260 of FIGS. 12F, 1270 of FIG. 12G). The touch-sensing system provided at stage 1502 includes a PUT array, a PFE (not PFE array), and optionally a steady-state force sensor. Such a touch-sensing system is illustrated in FIG. 11B, with a second touch sensor being omitted and a steady-state force sensor being optional. Multiple piezoelectric capacitors are arranged in an array in the implementations shown in FIGS. 12B-12G. In such implementations, two or more or all of the piezoelectric capacitors may be employed as PUTs and one of the piezoelectric capacitors may be used as a PFE. Process 1500 includes a PUT array-related left branch (stages 1310, 1312), a PFE-related middle branch (stage 1520), and a steady-state force sensor-related right branch (stage 1530). These branches may be carried out sequentially or concurrently. The left branch is as described with reference to FIG. 13A. In the example shown, stage 1530 is optional. Stage 1520 includes obtaining the PFE signals from voltage signals generated at the PFE in response to a low-frequency deformation of the cover stack. Herein, the term “low-frequency deformation” is used to refer to deformation is induced by touch excitation which is not repetitive (repetition rate is effectively 0 Hz) or is repetitive having a repetition rate of 100 Hz or less, or 10 Hz or less. These low frequencies are distinguishable from ultrasound waves (e.g., the ultrasound waves transmitted and/or received by PUTs), which typically have frequencies of 100 kHz to 50 MHz. The signal processor is configured to receive PFE signals from the PFE. For example, the PFE signals may undergo amplification, analog-to-digital conversion, and any other suitable signal conditioning (e.g., high-pass filtering, subtraction of noise), at the signal processor (and/or elsewhere). Stage 1530 includes obtaining the additional sensor signals. The signal processor is configured to receive the steady-state force sensor signals from the steady-state force sensor. For example, the steady-state force sensor signals may undergo amplification, analog-to-digital conversion, and any other suitable signal conditioning (e.g., subtraction of noise), at the signal processor (and/or elsewhere). Stage 1540 includes (1) determining whether a touch event has occurred and (2) determine an estimated touch position on the cover stack. The determining of whether a touch event has occurred is based on the touch data set comprising the PUT centroid data, the PFE signals, and, optionally, the steady-state force sensor signals. For example, a determination that a touch event has occurred may be made, with rejection of false positives, if the SNRs of the PUT centroid data, the SNR of the PFE signals, and (optionally) the SNR of the steady-state force sensor are sufficiently high. This determination may be made by the signal processor. A determination of the estimated touch position on the cover stack may be made in accordance with the PUT centroid data. This determination may be made by the signal processor.

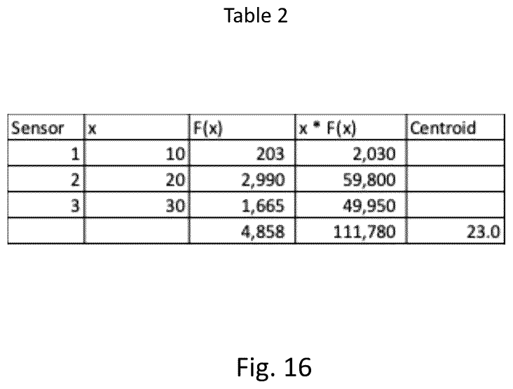

FIG. 16 (Table 2) shows one example of a calculation of centroid data from sensor array signals (e.g., PUT array signals, PFE array signals, additional sensor array signals). In the example shown, there are three sensors (sensors 1, 2, 3) located at respective positions (x) of 10, 20, and 30 (in arbitrary position units). Suppose that the signal values F(x) are 203, 2990, and 1665 for the respective sensors. A sum of the F(x) values is 4858. A product of the position and the signal values (x·F(x)) is shown for each respective sensor; the sum of x·F(x) values is 111,780. The centroid position (about 23.0) is given by dividing the sum of the x·F(x) values by the sum of the F(x) values. This centroid position is between sensor 2 and sensor 3 and closer to sensor 2.

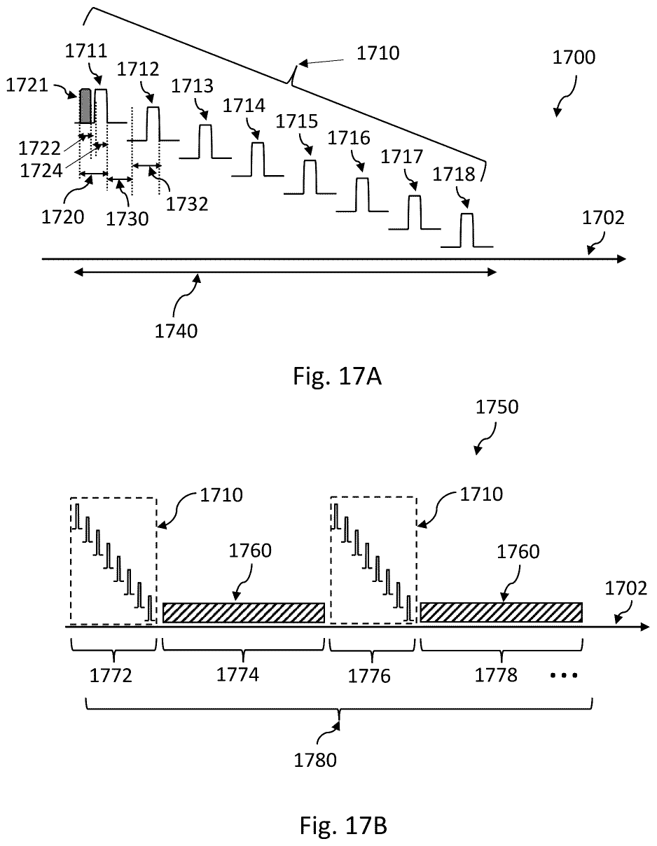

FIG. 17A is a schematic timing diagram 1700 showing the relationships among the signal portions of the signals received by the signal processor from the PUTs during a sensing event time frame 1740. FIG. 17B is a schematic timing diagram 1750 showing the relationships among the sensing event time frames 1772, 1776 and the signal processing time frames 1774, 1778 during a touch determination period 1780. Each of the sensing time frames 1772, 1776 (FIG. 17B) may correspond to sensing time frame 1740 (FIG. 17A). Timing diagrams 1700 and 1750 are shown with the x-axis 1702 indicating time. The signal timing is explained with reference to the eight PUTs shown at FIG. 10A and FIG. 10B. Timing diagram 1700 shows signals 1710 from the PUTs received at the signal processor 422. Signals 1710 comprise the following signal portions (ordered by time sequence): 1711 (signal portion from PUT 1021), 1712 (signal portion from PUT 1022), 1713 (signal portion from PUT 1023), 1714 (signal portion from PUT 1024), 1715 (signal portion from PUT 1025), 1716 (signal portion from PUT 1026), 1717 (signal portion from PUT 1027), and 1718 (signal portion from PUT 1028). Each of the signal portions occupies a respective portion of the sensing time frame 1740, and there is no overlap of the signal portions in time. Accordingly, these signal portions are in a time-division multiplexed arrangement.

Each of the signal portions (1711-1718) is generated in accordance with the ultrasound waves received at the respective PUTs (1021-1028) during a respective one of the sensing time windows (e.g., sensing time window 1720 is shown for signal portion 1711). Additional details are described for the example of PUT 1021. Sensing time window 1720 comprises a first time portion 1722 and a second time portion 1724 after the first time portion. During first time portion 1722, the transmitting-type PUT (e.g., PUT 1021 functioning as a transmitting-type PUT) transmits ultrasound waves towards the cover stack 102 in a predetermined frequency range (e.g., in a range of about 0.5 MHz (500 kHz) to about 20 MHz, or more broadly about 100 kHz to about 50 MHz), with the ultrasound waves propagating along a normal direction (along z-axis 1086) approximately normal to a plane of the one or more piezoelectric members. For example, when a drive voltage signal (e.g., voltage in a range of about 1 to about 50 V, frequency in a range of about 0.5 to about 20 MHz) is applied to the electrodes of a PUT, the PUT may transmit ultrasound waves of approximately the same frequency as the drive voltage along normal direction (along z-axis 1086). Such drive voltage signal may be generated by a suitable signal-generation circuit (e.g., circuitry in the signal processor 422 or other circuitry connected to (coupled to) PUT 1021). For illustration, the drive voltage signal applied to PUT 1021 during the first time portion 1722 is schematically shown as 1721 in FIG. 17A, although this drive voltage signal is not part of the signals 1710 received at the signal processor. The ultrasound waves undergo varying degrees of attenuation depending on objects (if any) in contact with the cover stack 102. A fraction of the ultrasound waves are reflected back towards the PUT(s) (e.g., PUT 1021).

During the second time portion 1724, the receiving-type PUT (e.g., PUT 1021 functioning as a receiving-type PUT) receives the ultrasound waves from the cover stack in the predetermined frequency range. The receiving-type PUT generates time-varying voltage signals in response to the received ultrasound signals. The signal processor (e.g., 422) receives a signal portion (e.g., 1711) that is generated in accordance with the ultrasound waves received at the receiving-type PUT (e.g., PUT 1021) during a respective sensing time window (e.g., 1720). In some implementations, the time-varying voltage signal generated at the receiving-type PUT may undergo amplification, analog-to-digital conversion (ADC), and/or other signal conditioning before it is received at the signal processor as a “signal portion”. In some implementations, a duration of each of the sensing time windows is about 0.1 μs or more, and/or about 1000 μs or less (e.g., in a range of about 0.1 μs to about 1000 μs). There is a second sensing time window 1732, associated with a second PUT 1022 and second signal portion 1712. In the example shown, there is a blank time window 1730 between adjacent sensing time windows 1720 and 1732.

FIG. 17B is a schematic timing diagram 1750 showing the relationships among the sensing event time frames 1772, 1776 and the signal processing time frames 1774, 1778 during a touch determination period 1780. Each of the sensing event time frames 1772, 1776 (FIG. 17B) may correspond to sensing event time frame 1740 (FIG. 17A). A touch determination period may include more than two sensing time event time frames. The touch sensor is active at least during the touch determination period (e.g., the touch sensor may also be active during other time periods). In some implementations, a duration of a touch determination period is about 100 ms or more, and/or about 3000 ms or less (e.g., in a range of about 100 ms to about 3000 ms). In some implementations, a duration of a sensing event time frame satisfies one or more of the following: about 100 μs or more, about 200 μs or more, about 10 ms or less, and about 2 ms or less. In some implementations, a duration of a sensing event time frame is in a range of about 100 μs to about 10 ms, about 100 μs to about 2 ms, about 200 μs to about 10 ms, or about 200 μs to about 2 ms. In the example shown, there are signal processing time frames interleaved with the sensing event time frames (e.g., signal processing time frame 1774 after sensing event time frame 1772 and before sensing event time frame 1778. In some implementations, a duration of a signal processing time frame may be in a range of about 1 μs to about 1 ms. The signal processor (e.g., 422) may carry out signal processing during the sensing event time frame and may carry out additional signal processing during the signal processing time frame. In some implementations, signals are received from the PUTs during the sensing event time frames whereas no signals are received from the PUTs during the signal processing time frames. However, other signals (e.g., signals from other sources, such as a wake-up sensor, an external signal source, or another sensor) may be received by the signal processor during the signal processing time frame. In some implementations, an example of another sensor is a piezoelectric force-measuring element (PFE). In some implementations, a piezoelectric capacitor that function as transmitting-type PUTs and/or receiving-type PUT during a sensing event time frame also functions as a PFE during a signal processing time frame.

During the sensing event time windows (e.g., 1772, 1776) (and additionally during the signal processing time frames 1774, 1778, in some implementations), the signal processor determines, from at least the signals (e.g., the signals from the PUTs during the sensing time windows, and optionally additional signals from the PFEs during the signal processing time windows), whether a touch event has occurred (e.g., a finger touch, finger press, finger slide, or another object contacting the cover stack), and at least one other characteristic of the touch event, if the signal processor has determined that the touch event has occurred. Herein, examples of “other characteristics” include touch velocity, touch direction, touch pattern, and touch location. In some cases, determining one of these other characteristics requires a determination of touch location(s). For example, determining a touch velocity may include (1) determining a first location and a first time at which a finger initially touches the outer surface 104 (of the cover stack 102) and starts to slide across the cover stack and (2) determining a second location and a second time (after the first time) at which the finger stops sliding and lifts away from the cover stack. For example, determining a touch pattern includes determining a series of touch locations at which a finger touches the cover stack. Other examples of “other characteristics” include transient applied force and transient strain. Characteristics such as transient strain and transient applied force may be determined in implementations in which the piezoelectric capacitor(s) function as PFE(s) during signal processing time frames. In such implementations, the other characteristics may be determined in accordance with the signals from the PUTs and the additional signals from the PFEs.

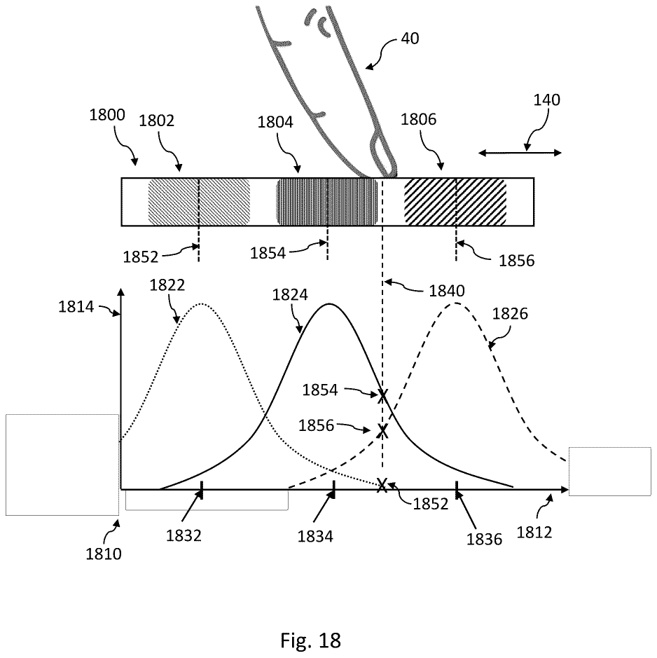

FIG. 18 is a schematic diagram of the response curves of three illustrative touch-sensing elements, illustrating a concept of determining a touch location. An illustrative sensor assembly 1800 includes an array of PUTs (1802, 1804, 1806) extending along a longitudinal direction 140. In the example shown, a finger 40 is contacting the outer surface (of the cover stack) at a touch location 1840 (along the longitudinal direction 140). A graphical plot 1810 shows a respective response curve for each of the PUTs (response curve 1822 for PUT 1802, response curve 1824 for PUT 1804, response curve 1826 for PUT 1806). A response curve indicates a characteristic response (along y-axis 1814, in arbitrary units such as LSBs) of the PUT at each location along the x-axis 1812. Response curve 1822 exhibits a peak around x-axis position 1832, which is quite close to a central point 1852 of the PUT 1802 (along longitudinal axis 140). Response curve 1824 exhibits a peak around x-axis position 1834, which is quite close to a central point 1854 of the PUT 1804 (along longitudinal axis 140). Response curve 1826 exhibits a peak around x-axis position 1836, which is quite close to a central point 1856 of the PUT 1806 (along longitudinal axis 140). Accordingly, (1) each of the response curves has a peak at a central point and decreases with increasing distance away from the central point, and (2) two (or more) adjacent response curves are overlapped. In the example shown, the finger touch point 1840 is between PUT 1804 and PUT 1806. In some implementations, the response curves are indicative of signals at the signal processor, after amplification, analog-to-digital conversion (ADC), and other signal conditioning. Since the touch location 1840 is relatively far from the left PUT 1802, the response of the left PUT (at point 1852) is quite low, near a tail end of the response curve 1822. Since the touch location 1840 is closest to the middle PUT 1804, the response of the middle PUT (at point 1854) is quite high. Furthermore, the response of the right PUT (at point 1856) is between the responses of the left and middle PUTs. Since there is a response from two (or more, in the example shown three) PUTs, a touch location may be calculated or estimated from the comparing the response to the known response characteristics (e.g., response curves, peak response height, peak response location) of the PUTs.

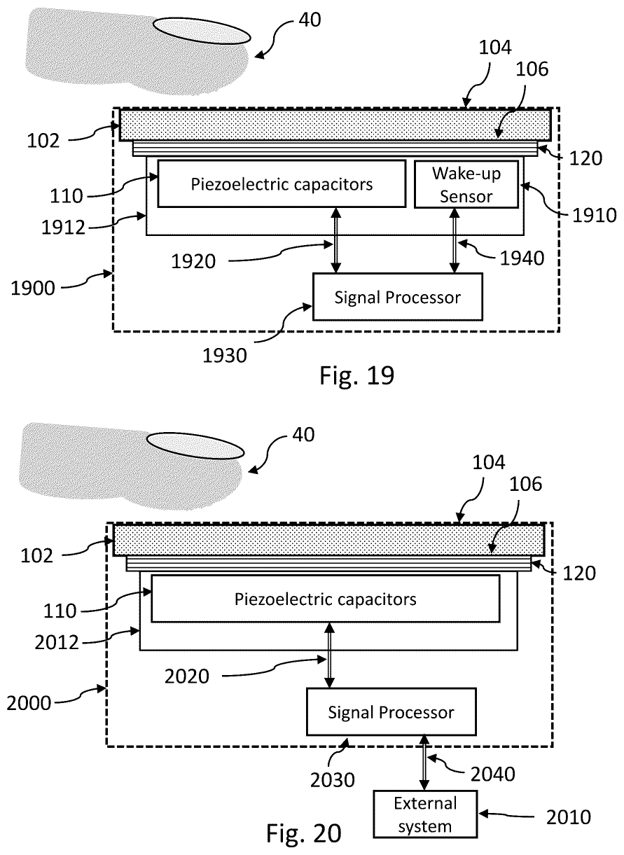

FIG. 19 is a schematic view of an illustrative touch-sensing system (e.g., touch-sensing slider) 1900 that additionally includes a wake-up sensor 1910. Touch-sensing system 1900 differs from touch-sensing system 100 (FIG. 1A) in some respects. In the example shown, sensor assembly 110 and wake-up sensor 1910 are encapsulated in a protective package 1912. Signal processor 1930 is connected via a bus (or other signal interconnection) 1920 to sensor assembly 110 and is also connected via a bus (or other signal interconnection) 1940 to wake-up sensor 1910. In some implementations, the sensor assembly and wake-up sensor may share a common bus connection to the signal processor. In some implementations, the wake-up sensor may be outside of any package that includes the sensor assembly. In some implementations, a piezoelectric force-measuring element (PFE) (including a piezoelectric micromechanical force-measuring element (PMFE)) may be employed as a wake-up sensor. In some implementations, a piezoresistive strain gauge or an accelerometer may be used as a wake-up sensor. Other sensors may be used as a wake-up sensor. The signal processor is configured to receive wake-up signals from the wake-up sensor.

FIG. 20 is a schematic view of an illustrative touch-sensing system (e.g., touch-sensing slider) 2000 in which the signal processor is configured to receive wake-up signals from an external source 2010. Touch-sensing system 2000 differs from touch-sensing system 1900 (FIG. 19) in some respects. In the example shown, there is no wake-up sensor in the touch-sensing system. Signal processor 2030 is connected via a bus (or other signal interconnection) 2020 to sensor assembly 110 and is also connected via a bus (or other signal interconnection) 2040 to an external system 2010. While signal processor 1930 (FIG. 19) may also be connected to an external system (not shown), signal processor 2030 is configured to receive wake-up signals from external system 2010 (e.g., via bus connection 2040). Examples of an external system 2010 include an application processor and a microcontroller (MCU). In some implementations, the touch-sensing system is configured to operate in one of multiple modes including a lower-power mode and a higher-power mode. The sensor assembly is active in the higher-power mode and is inactive in the lower-power mode. It may be preferable to operate the touch-sensing in a lower-power mode most of the time and change to the higher-power mode only when necessary. A touch determination period (1780, FIG. 17B) is an example of a time period in which the touch-sensing system is in the higher-power mode. The signal processor is configured to receive wake-up signals (e.g., from the wake-up sensor 1910 coupled to the signal processor or from an external source 2010). The signal processor is configured to determine whether to activate the sensor assembly in accordance with the wake-up signals.

In some implementations, wake-up signals may be indicative of one or more of the following: (a) acceleration of an object, (b) vibration of an object, (c) force or pressure applied to an object, (d) a status of a user-interface device, and (e) a proximity of an object to the touch-sensing system. Herein, “an object” may refer to a larger system of which the touch-sensing system is a part. For example, the object may be a smartphone that incorporates the touch-sensing system. Acceleration of, vibration of, or force or pressure applied any portion of the smartphone, that exceeds a predetermined threshold, may prompt a wake-up signal. Herein, a “status of a user-interface device” may refer to a status of a user-interface device of a larger system of which the touch-sensing system is a part. For example, the user-interface device may be a touch screen of a larger system and its status may be that the touch screen is on. For example, the user-interface device may be an image sensing system of a smart doorbell (that incorporates the touch-sensing system), and its status may be that there is a person approaching the smart doorbell as determined by the image sensing system. For example, the user-interface device may be a speaker of a larger system, and its status may be that the speaker is on (e.g., playing music, playing a telephone conversation). For example, the user-interface device may be a microphone of a larger system, and its status may be that the microphone is on (e.g., a person is speaking). Herein, “a proximity of an object to the touch-sensing system” may applied in many suitable situations. For example, a touch-sensing system may be employed in an automobile, as part of an access-control device or another user-interface device thereof. A matching RFID (radio frequency identification)-enabled automobile key approaching the automobile may be detected and may prompt a wake-up signal. For example, a touch-sensing system may be employed in a device that is enabled for wireless communication (e.g., Bluetooth). A matching device approaching a system incorporating the touch-sensing system may be detected and may prompt a wake-up signal.

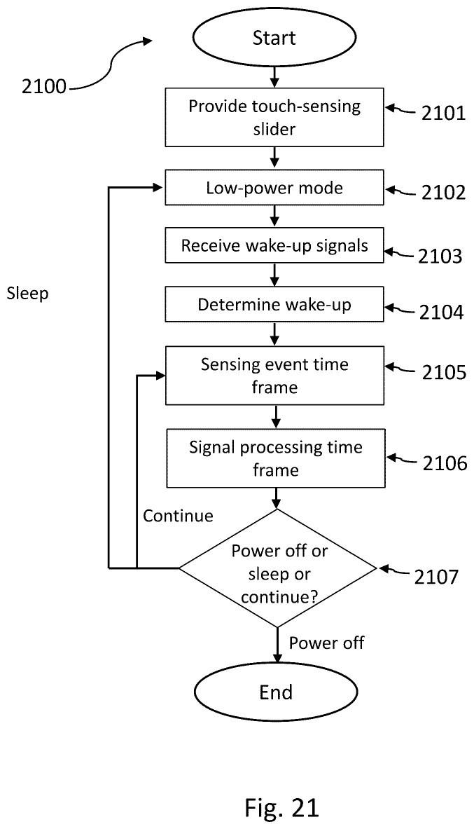

FIG. 21 is a flow diagram of a process of sensing touch in accordance with some embodiments. Process 2100 includes stages 2101-2107. At 2101, a touch-sensing system, as described herein, is provided. Initially, the touch-sensing system may be in a lower-power mode (stage 2102). It is not necessary that the touch-sensing system configured to operate in a lower-power mode in addition to the higher-power mode. If the touch-sensing system always operates in the higher-power mode, then stages 2102-2104 may be omitted and stages 2105-2107 may be carried out. At 2103, a wake-up signal may be received by the signal processor, as described with reference to FIG. 19 and FIG. 20. At 2104, the signal processor determines whether to activate the sensor assembly in accordance with the wake-up signals. If the signal processor determines to activate the sensor assembly, stages 2105-2107 are carried out. At 2105, the following actions are carried out during the sensing event time frame: (1) one or more of the transmitting-type PUTs transmit the ultrasound waves during each of the sensing time windows (e.g., see FIG. 17A, FIG. 17B, and related detailed description); (2) one or more of the receiving-type PUTs receive the ultrasound waves during each the sensing time windows (e.g., see FIG. 17A, FIG. 17B, and related detailed description); and (3) the signal processor receives the signals from the PUTs. The signals comprise signal portions in a time-division multiplexed arrangement, with each of the signal portions being generated in accordance with the ultrasound waves received at the one or more of the receiving-type PUTs during a respective one of the sensing time windows (e.g., see FIG. 17A, FIG. 17B, and related detailed description). Furthermore, at 2105, during the sensing event time frame, the signal processor determines, from at least the signals (e.g., the signals from the PUTs and any additional available signals), whether a touch event has occurred (see FIG. 4C and related detailed description). Yet furthermore, at 2105, during the sensing event time frame, the signal processor determines, from at least the signals (e.g., the signals from the PUTs and any additional available signals), at least one other characteristic of the touch event, if the signal processor has determined that the touch event has occurred (see FIG. 17A, FIG. 17B, FIG. 18, and related detailed description). Stage 2106 relates to any actions that are carried out during an optional signal processing time frame. Signal processing time frames are interleaved with sensing event time frames. At 2106, additional signal processing may be carried out, to determine, for example, (1) whether a touch event has occurred, and/or (2) at least one other characteristic of the touch event, if the signal processor has determined that the touch event has occurred. During the signal processing time frames, additional signals (i.e., other than the signals received from the PUTs during the sensing event time frames) may be available. An example of such additional signals is signals from PFEs during the signal processing time frames. Additional signal processing on such a combination of PUT and PFE signals may improve false positive rejection (e.g., better exclude events at the outer surface that are not touch events) and may also enable determination of other characteristics of the touch event such as the transient applied force or transient strain.

In some implementations, stages 2105-2106 may be repeated for all of the sensing event time frames of a touch determination period, although this repetition is not specifically indicated in FIG. 21. At 2107, three or more options are possible. A first option is that the touch-sensing system powers off. For example, this may occur if the power supply is turned off or a battery power source is depleted. A second option is that the touch-sensing system goes into a lower-power mode (e.g., the sensor assembly is inactive in the lower-power mode) upon completion of a touch determination period. Otherwise, a third option is that stages 2105-2107 are repeated for additional time beyond the touch determination period. In some implementations, a touch determination period may be in a range of 1 ms to 3000 ms, in a range of 1 ms to 100 ms, in a range of 100 ms to 1000 ms, or in a range of 1000 ms to 3000 ms.

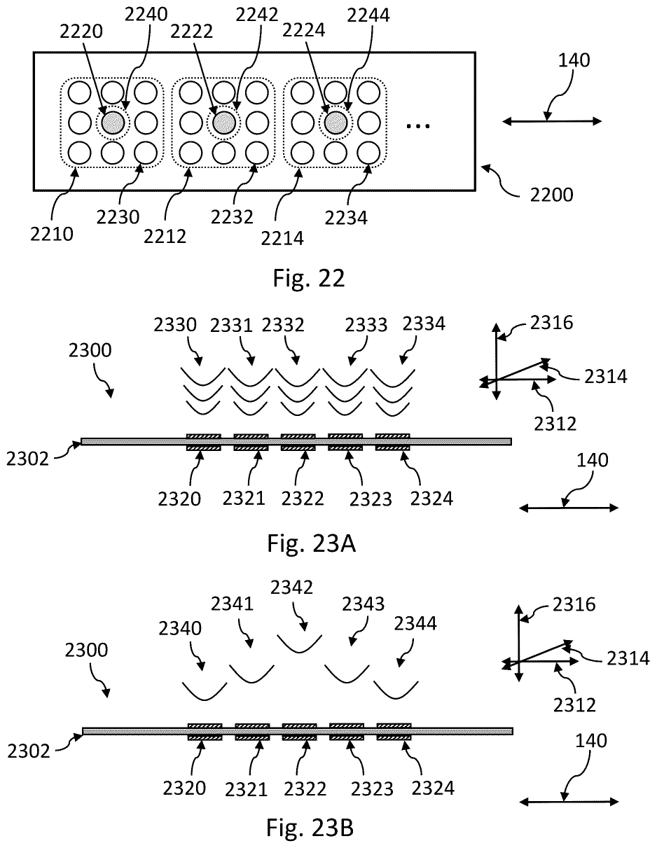

FIG. 22 is a schematic plan view of an array 2200 of PUTs including transmitting-type PUTs and receiving-type PUTs. The array 2200 extends along a longitudinal direction 140. In the example shown, there are three touch-sensing elements (2210, 2212, 2214). Touch-sensing element (2210, 2212, 2214) includes transmitting-type PUTs (2230, 2232, 2234) (indicated as white circles, there are 8 transmitting-type PUTs for each touch-sensing element) and a receiving-type PUT (2220, 2222, 2224) (grey circles). In the example shown, each of the PUTs is either a transmitting-type PUT, or a receiving-type PUT but not both. In the example shown, the transmitting-type PUTs surround a receiving-type PUT in the middle. Furthermore, the PUTs are shown as being approximately circular or approximately round whereas other examples PUTs (e.g., FIG. 2, FIG. 3, FIG. 9B) are shown as being approximately rectangular or approximately square. One advantage of the arrangement of FIG. 22 in which there are more transmitting-type PUTs than receiving-type PUTs (e.g., in the example shown, a ratio of transmitting-type PUTs to receiving-type PUTs is 8:1, with the PUTs being about the same in area) is that the power of the transmitting ultrasound waves may be increased. In some implementations, the power enhancement may be attained when the ultrasound waves transmitted by the transmitting-type PUTs interfere constructively.

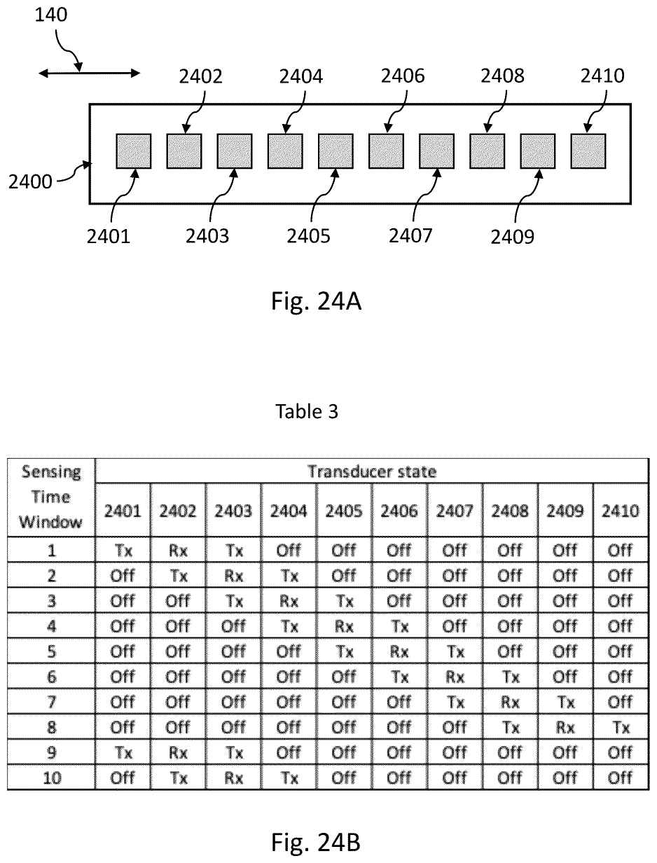

FIG. 23A is a schematic elevational view of a sensor assembly 2300 comprising a piezoelectric member 2302 and PUTs 2320-2324 at respective locations along the piezoelectric member 2302. The PUTs are arrayed along the longitudinal direction 140. The plane of the piezoelectric member is approximately parallel to the plane formed by the x-axis 2312 and the y-axis 2314. FIG. 23A schematically shows respective example waveforms (2330-2334) transmitted by each of the PUTs (2320-2324). These transmitted waveforms propagate along the normal direction (direction of the z-axis 2316, direction approximately normal to the plane of the piezoelectric member). In the example shown (FIG. 23A), the ultrasound waves transmitted from each of the PUTs are independent of the ultrasound waves transmitted by other ones of the PUTs. Accordingly, there is no constructive interference in the example of FIG. 23A. The ultrasound waves expand laterally as they travel further away from the transmitting PUT. FIG. 23B shows the same sensor assembly 2300 as in FIG. 23A. FIG. 23B schematically shows respective example waveforms (2340-2344) transmitted by each of the PUTs (2320-2324). In the example shown (FIG. 23B), the waveform 2342 at the center (transmitted by central PUT 2322) is followed, with a predetermined phase delay, by waveforms 2341, 2343 outside of the center (transmitted by PUTs 1721, 1723), which in turn are followed, with a predetermined phase delay, by waveforms 2340, 2344 further outside of center (transmitted by PUTs 2320, 2324). These ultrasound waves interfere constructively and form a beam that converges near a point above the central PUT 2322 (e.g., a point above the central PUT 2322 at the outside surface of the cover stack, when the cover stack and the sensor assembly are assembled together and mechanically coupled to each other). This is an example of beam-forming, in which ultrasound waves transmitted from multiple PUTs are constructively interfered to form a unified wavefront. Accordingly, in this manner, waveforms with relatively narrow beamwidths may be obtained. In some implementations, the ultrasound waves transmitted by the transmitting-type PUTs have a beamwidth in a range of 100 μm to 10 mm at the outer surface of the cover stack. In some implementations, the lateral dimensions of the PUTs (piezoelectric capacitors) are in a range of about 100 μm to about 10 mm, and the beamwidths are comparable to these lateral dimensions.

FIG. 24A is a schematic plan view of an array 2400 of PUTs (2401-2410), extending along the longitudinal direction 140. FIG. 24B shows a Table 3, showing the transducer states for each of the PUTs of FIG. 24A at each sensing time window. Herein, Tx indicates that the PUT is in transmission mode (is a transmission-type PUT) during that sensing time window, Rx indicates that the PUT is in receiving mode (is a receiving-type PUT) during that sensing time window, and “Off” indicates that the PUT is neither transmitting nor receiving during that sensing time window. For example, a PUT may be connected to a transmit/receive (T/R) switch. When the PUT is in transmit mode, it may be connected to a driver circuit via the T/R switch, and when the PUT is in the receive mode, it may be connected to a receive circuit via the T/R switch. For illustration, ten sensing time windows are shown in Table 3. For example, during sensing time window #1, PUT 2401 is transmitting, PUT 2402 is receiving, PUT 2403 is transmitting, and PUTs 2404-2410 are in “Off” state. Accordingly, during sensing time window #1, PUTs 2401-2403 constitute the touch-sensing element. It may be preferable to synchronize the operation of the transmitting PUTs 2401 and 2403 so that their ultrasound waves interfere constructively. In some implementations, a greater ultrasound power output and a better signal-to-noise performance may be obtained by using multiple PUTs for transmission than by using a single PUT for transmission. During sensing time window #2, PUT 2402 is transmitting, PUT 2403 is receiving, PUT 2404 is transmitting, and PUTs 2401 and 2405-2410 are in “Off” state. Accordingly, during sensing time window #1, PUTs 2402-2404 constitute the touch-sensing element. The touch-sensing element moves (e.g., shifts rightward along longitudinal axis 140) for each subsequent sensing time window. Eventually, at sensing time window #9, the touch-sensing element is at the same location as was at sensing time window #1. In the example shown, the PUTs that have only one neighboring PUT (i.e., leftmost PUT 2401 and rightmost PUT 2410) have transmitting and “Off” modes while the PUTs that have two neighboring PUTs (i.e., the interior PUTs 2402-2409) have transmitting, receiving, and “Off” modes. Accordingly, by employing each PUT to function in multiple modes (e.g., transmitting, as well as receiving, for some PUTs), the total number of PUTs required to implement a certain number of touch-sensing elements is reduced, compared to arrangements in which each PUT is dedicated as a transmitting-type PUT or a receiving-type PUT. In other implementations, the leftmost PUT 2401 and rightmost PUT 2410 may additionally have a receiving mode. In yet other implementations, at least one (e.g., one, two, three, all) of the piezoelectric capacitors (2401-2410) may also be configured as PFE(s) (e.g., during signal processing time frames).

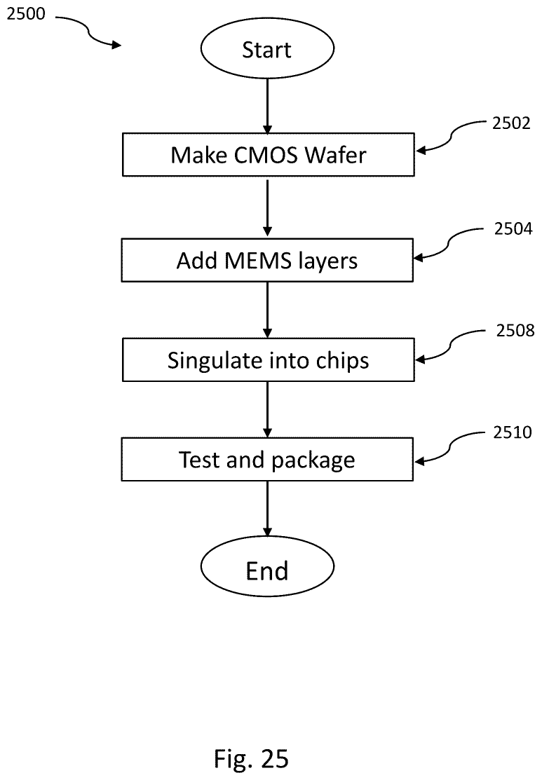

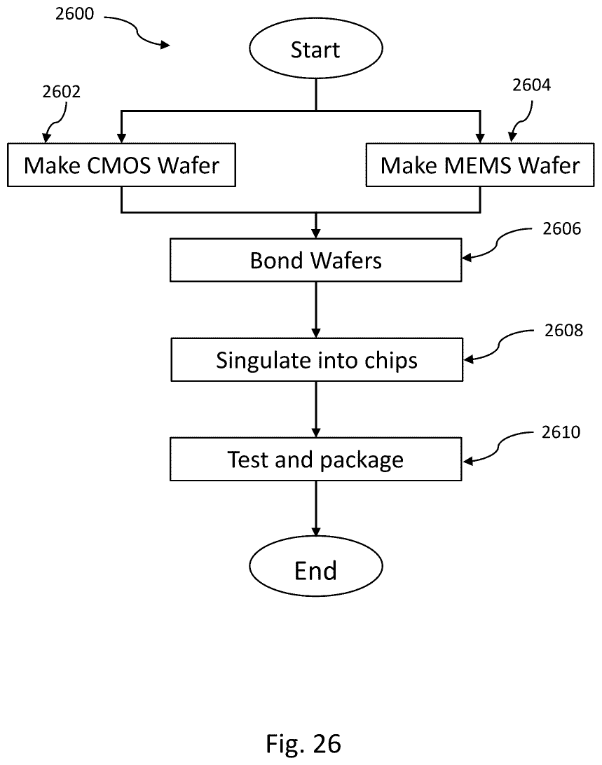

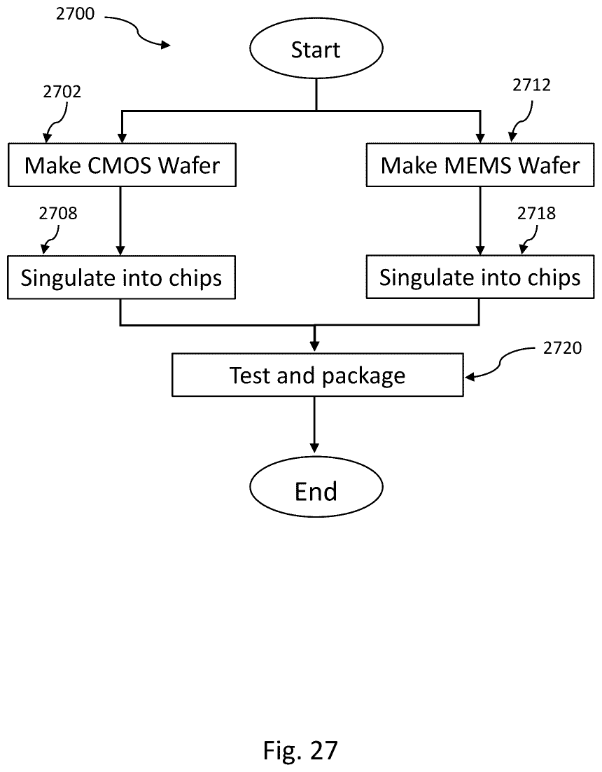

FIG. 25, FIG. 26, and FIG. 27 are used to illustrate variations in manufacturing processes and structures of touch sensor ICs. FIG. 25 is a flow diagram of a process 2500 of making a monolithic IC (integrated circuit) incorporating a CMOS (complementary metal-oxide semiconductor) portion and a MEMS (micro-electro-mechanical systems) portion. Process 2500 may be employed to make a touch sensor IC that includes a MEMS portion (including PMUTs) and a CMOS portion incorporating a signal processor. Herein, the term “monolithic IC” is used to refer to an IC device that has been singulated from a single wafer (e.g., silicon wafer). In the examples illustrated in FIG. 6 and FIG. 7, the touch sensor devices (e.g., 610, 710) may be touch sensor ICs. Process 2500 includes stages 2502, 2504, 2508, and 2510. At stage 2502, CMOS processing is carried out on a substrate (e.g., silicon wafer) to form CMOS circuitry (e.g., signal processor). At stage 2504, MEMS processing is carried on the same substrate to form MEMS devices (e.g., PMUTs, PMFEs). Upon completion of stage 2504, the substrate includes a CMOS portion on top of the substrate and a MEMS portion on top of the CMOS portion. At stage 2508, the substrate is singulated into chips. At stage 2510, the chips undergo back-end processing including testing and packaging.

FIG. 26 is a flow diagram of a process 2600 of making a wafer-bonded IC incorporating a CMOS (complementary metal-oxide semiconductor) wafer portion and a MEMS (micro-electro-mechanical systems) wafer portion. Process 2600 may be employed to make a touch sensor IC that includes a MEMS portion (including PMUTs) and a CMOS portion incorporating a signal processor. Process 2600 includes stages 2602, 2604, 2606, 2608, and 2610. At stage 2602, CMOS processing is carried out on a first substrate (e.g., silicon wafer) to form CMOS circuitry (e.g., signal processor). At stage 2604, MEMS processing is carried on a second substrate (e.g., silicon wafer, as well as other options such as glass substrate, quartz substrate, etc.) to form MEMS devices (e.g., PMUTs, PMFEs). At stage 2606, the first substrate and second substrate are adhered to each other, by a wafer-bonding process. At stage 2608, the wafer-bonded substrate assembly is singulated into chips. At stage 2610, the chips undergo back-end processing including testing and packaging.

FIG. 27 is a flow diagram of a process 2700 of making a system in a package (SiP) incorporating a CMOS IC and a MEMS IC. Process 2700 includes stages 2702, 2708, 2712, 2718, and 2720. At stage 2702, CMOS processing is carried out on a first substrate (e.g., silicon wafer) to form CMOS circuitry (e.g., signal processor). At stage 2708, the first substrate after CMOS processing is singulated into CMOS chips. At stage 2712, MEMS processing is carried on a second substrate (e.g., silicon wafer, as well as other options such as glass substrate, quartz substrate, etc.) to form MEMS devices (e.g., PMUTs, PMFEs). At stage 2718, the second substrate after MEMS processing is singulated into MEMS chips. At stage 2720, the CMOS chips and the MEMS chips undergo back-end processing including testing and packaging into SiPs.

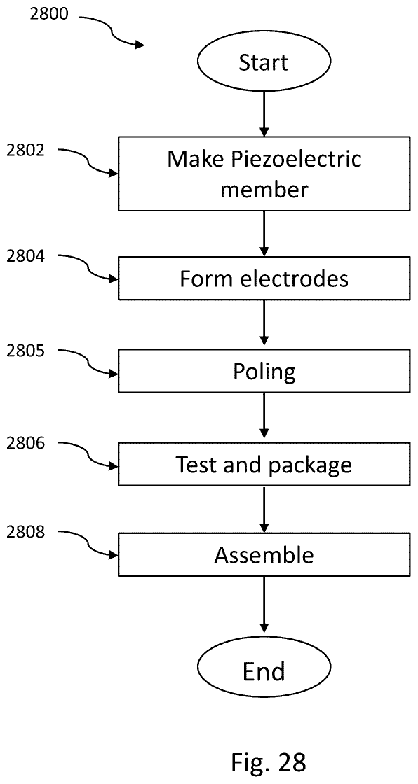

FIG. 28 is a flow diagram of a process 2800 of making a touch sensor device incorporating discrete (e.g., non-micromechanical) piezoelectric capacitors. Process 2800 includes stages 2802, 2804, 2805, 2806, and 2808. At stage 2802, a piezoelectric member is made or provided, to the desired dimensions. As described with reference to FIG. 4B and FIG. 4C, a piezoelectric member may be shared among multiple piezoelectric capacitors, or a respective piezoelectric member may be made or provided for each piezoelectric capacitor. At stage 2804, electrodes are formed on the piezoelectric member(s) to obtain the piezoelectric capacitors. At stage 2805, a poling operation may be carried out: a voltage is applied to the piezoelectric member between the electrodes (e.g., the electrodes formed at stage 2804) to form a built-in piezoelectric polarization. At stage 2806, the piezoelectric capacitors may undergo any necessary testing and packaging. As described with reference to FIG. 10A and FIG. 10B, the necessary packaging may be minimal in some implementations. At stage 2808, the piezoelectric capacitors may undergo final assembly into a larger system, such as mounting (e.g., solder bonding to a circuit board substrate).

Additional information about piezoelectric micromechanical force-measuring elements (PMFEs) and piezoelectric micromechanical ultrasonic transducers (PMUTs) can be found in U.S. Patent Application Publication Nos. US 2021/0181041 A1 and US 2021/0242393 A1. Additional information about discrete piezoelectric capacitors generally may be found in U.S. Patent Application Publication No. 2021/0242393 A1.

In this disclosure, the words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention. The recitations of numerical ranges by endpoints include all numbers subsumed within that range (e.g., 1 to 5 includes 1, 1.5, 2, 2.75, 3, 3.80, 4, 5, etc.). 1For any method disclosed herein that includes discrete steps, the steps may be conducted in any feasible order. As appropriate, any combination of two or more steps may be conducted simultaneously.

### EXAMPLES

In some aspects, the techniques described herein relate to a touch-sensing system, comprising: a cover stack having an outer surface that can be touched by a finger, the cover stack having a longitudinal direction along which the finger can touch and slide on the outer surface; piezoelectric capacitors mechanically coupled to the cover stack at its inner interface, the cover stack overlying the piezoelectric capacitors, the piezoelectric capacitors comprising one or more piezoelectric members; a first array of at least two of the piezoelectric capacitors configured as piezoelectric ultrasonic transducers (PUTs); a second array of at least two of the piezoelectric capacitors configured as piezoelectric force-measuring elements (PFEs); and a signal processor configured to receive PUT array signals from the PUTs and PFE array signals from the PFEs, wherein: each of the PUTs is configured as a transmitting-type PUT and/or a receiving-type PUT, the receiving-type PUTs numbering at least two in the first array; the first array and the second array extend along at least one direction including the longitudinal direction; the transmitting-type PUTs are configured to transmit ultrasound waves towards the cover stack in a predetermined frequency range, the ultrasound waves propagating along a normal direction approximately normal to a plane of the one or more piezoelectric members; the receiving-type PUTs are configured to receive the ultrasound waves from the cover stack in the predetermined frequency range; the PUT array signals are generated in accordance with the ultrasound waves received at the receiving-type PUTs; the PFE array signals are obtained from voltage signals generated at the PFEs in response to a low-frequency deformation of the cover stack; the signal processor is configured to calculate, from the PUT array signals, PUT centroid data; the signal processor is configured to calculate, from the PFE array signals, PFE centroid data; the signal processor is configured to determine, whether a touch event on the cover stack has occurred; and the signal processor is configured to determine an estimated touch position on the cover stack by combining applicable centroid data comprising the PUT centroid data and the PFE centroid data, the PUT centroid data being apportioned a PUT fractional weight w(PUT), the PFE centroid data being apportioned a PFE fractional weight w(PFE).

In some aspects, the techniques described herein relate to a touch-sensing system, wherein the PUT fractional weight w(PUT) and the PFE fractional weight w(PFE) are time-varying.

In some aspects, the techniques described herein relate to a touch-sensing system, wherein: the PUT centroid data are characterized by a PUT signal-to-noise ratio (PUT SNR); the PFE centroid data are characterized by a PFE signal-to-noise ratio (PFE SNR); and the PUT fractional weight w(PUT) and the PFE fractional weight w(PFE) vary in accordance with temporal changes to the PUT SNR and/or temporal changes to the PFE SNR.

In some aspects, the techniques described herein relate to a touch-sensing system, wherein: the PUT fractional weight w(PUT) is wₐ(PUT) and the PFE fractional weight w(PFE) is wₐ(PFE) if the PUT SNR is greater than a PUT SNR threshold and the PFE SNR is greater than a PFE SNR threshold, (b) the PUT fractional weight w(PUT) is w_{b}(PUT) and the PFE fractional weight w(PFE) is w_{b}(PFE) if the PUT SNR is not greater than the PUT SNR threshold and the PFE SNR is greater than the PFE SNR threshold, (c) the PUT fractional weight w(PUT) is w_{c}(PUT) and the PFE fractional weight w(PFE) is w_{c}(PFE) if the PUT SNR is greater than the PUT SNR threshold and the PFE SNR is not greater than the PFE SNR threshold; the following relationships are satisfied: w_{b}(PUT)<wₐ(PUT), w_{b}(PFE)>wₐ(PFE), w_{c}(PUT)>wₐ(PUT), and w_{c}(PFE)<wₐ(PFE); and the following relationships are satisfied: wₐ(PUT)+wₐ(PFE)≤1, w_{b}(PUT)+w_{b}(PFE)≤1, and w_{c}(PUT)+w_{c}(PUT)≤1.

In some aspects, the techniques described herein relate to a touch-sensing system, wherein one or more of the following relationships are satisfied: a ratio of wₐ(PUT) to wₐ(PFE) is in a range of 40:60 to 60:40; a ratio of w_{b}(PUT) to w_{b}(PFE) is in a range of 0:100 to 35:65; and a ratio of w_{c}(PUT) to w_{c}(PFE) is in a range of 65:35 to 100:0.

In some aspects, the techniques described herein relate to a touch-sensing system, wherein one or more of the following relationships are satisfied: the ratio of wₐ(PUT) to wₐ(PFE) is in a range of 45:55 to 55:45; the ratio of w_{b}(PUT) to w_{b}(PFE) is in a range of 0:100 to 30:70; and the ratio of w_{c}(PUT) to w_{c}(PFE) is in a range of 70:30 to 100:0.

In some aspects, the techniques described herein relate to a touch-sensing system, wherein the cover stack is configured as at least one button.

In some aspects, the techniques described herein relate to a touch-sensing system, further comprising: a third array of additional sensors configured to output additional sensor array signals, wherein: the third array extends along the at least one direction; the signal processor is configured to receive the additional sensor array signals; the signal processor is configured to calculate, from the additional sensor array signals, additional sensor centroid data; and the applicable centroid data further comprise the additional sensor centroid data, the additional sensor centroid data being apportioned an additional sensor fractional weight w(AS).

In some aspects, the techniques described herein relate to a touch-sensing system, wherein the PUT fractional weight w(PUT), the PFE fractional weight w(PFE), and the additional sensor fractional weight w(AS) are time-varying.

In some aspects, the techniques described herein relate to a touch-sensing system, wherein: the PUT centroid data are characterized by a PUT signal-to-noise ratio (PUT SNR); the PFE centroid data are characterized by a PFE signal-to-noise ratio (PFE SNR); the additional sensor centroid data are characterized by an additional sensor signal-to-noise ratio (AS SNR); and the PUT fractional weight w(PUT), the PFE fractional weight w(PFE), and the additional sensor fractional weight w(AS) vary in accordance with temporal changes to one or more of the PUT SNR, the PFE SNR, and the AS SNR.

In some aspects, the techniques described herein relate to a touch-sensing system, wherein the additional sensors are capacitive touch sensors.

In some aspects, the techniques described herein relate to a touch-sensing system, wherein: the capacitive touch sensors are interposed between the cover stack and the piezoelectric capacitors; the capacitive touch sensors are mechanically coupled to the cover stack and the piezoelectric capacitors; and the cover stack is electrically non-conductive.

In some aspects, the techniques described herein relate to a touch-sensing system, wherein: the cover stack is a first cover stack; the piezoelectric capacitors are first piezoelectric capacitors; the touch-sensing system further comprises: a second cover stack adjacent the first cover stack, having an outer surface that can be touched by the finger; and one or more second piezoelectric capacitors mechanically coupled to the second cover stack at its inner surface, the second cover stack overlying the one or more second piezoelectric capacitors; the one or more second piezoelectric capacitors are configured as PUTs and/or PFEs; the signal processor is configured to receive second piezoelectric capacitor signals from the one or more second piezoelectric capacitors; the signal processor is configured to determine, from at least the second piezoelectric capacitor signals, whether a touch event on the second cover stack has occurred; and the signal processor is configured to determine, from at least the second piezoelectric capacitor signals, an estimated touch position on the second cover stack.

In some aspects, the techniques described herein relate to a touch-sensing system, wherein the second cover stack is configured as a frame.

In some aspects, the techniques described herein relate to a touch-sensing system, wherein the second cover stack is electrically conductive.

In some aspects, the techniques described herein relate to a touch-sensing system, wherein the additional sensors are steady-state force sensors.

In some aspects, the techniques described herein relate to a touch-sensing system, wherein the steady-state force sensors are strain gauges or parallel plate force sensors.

In some aspects, the techniques described herein relate to a touch-sensing system, further comprising: a haptic module comprising a haptic actuator and a haptic controller, the haptic actuator being vibrationally coupled to the cover stack, wherein the haptic controller is configured to drive the haptic actuator in accordance with haptic feedback commands from the signal processor.

In some aspects, the techniques described herein relate to a touch-sensing system, wherein at least two of the piezoelectric capacitors share a common piezoelectric member among the one or more piezoelectric members.

In some aspects, the techniques described herein relate to a touch-sensing system, wherein at least two of the piezoelectric capacitors share a common electrode.

In some aspects, the techniques described herein relate to a touch-sensing system, wherein: the PUTs are piezoelectric micromechanical ultrasonic transducers (PMUTs); the PFEs are piezoelectric micromechanical force-measuring elements (PMFEs); and the PMUTs and the PMFEs are part of a monolithic IC.

In some aspects, the techniques described herein relate to a touch-sensing system, wherein the monolithic IC comprises the signal processor.

In some aspects, the techniques described herein relate to a touch-sensing system, wherein at least one of the piezoelectric capacitors are adhered to the cover stack at the inner interface by an adhesive comprising double-sided tape, pressure sensitive adhesive (PSA), epoxy adhesive, or acrylic adhesive.

In some aspects, the techniques described herein relate to a touch-sensing system, wherein: at least the piezoelectric capacitors are encapsulated in a molded package; and at least a portion of the molded package is configured as the cover stack.

In some aspects, the techniques described herein relate to a touch-sensing system, wherein the one or more piezoelectric members comprise aluminum nitride, scandium-doped aluminum nitride, polyvinylidene fluoride (PVDF), lead zirconate titanate (PZT), potassium sodium niobate (KₓNa₁₋ₓNbO₃) (KNN), barium titanate (BaTiO₃) (BT), bismuth ferrite (BiFeO₃) (BFO), quartz, zinc oxide, lithium niobate, or bismuth sodium titanate (Bi_{0.5}Na_{0.5}TiO₃) (BNT).

In some aspects, the techniques described herein relate to a method of sensing touch, the method comprising: providing a touch-sensing system, comprising: a cover stack having an outer surface that can be touched by a finger, the cover stack having a longitudinal direction along which the finger can touch and slide on the outer surface; piezoelectric capacitors mechanically coupled to the cover stack at its inner interface, the cover stack overlying the piezoelectric capacitors, the piezoelectric capacitors comprising one or more piezoelectric members; a first array of at least two of the piezoelectric capacitors configured as piezoelectric ultrasonic transducers (PUTs), each of the PUTs being configured as a transmitting-type PUT and/or a receiving-type PUT, the receiving-type PUTs numbering at least two in the first array; a second array of at least two of the piezoelectric capacitors configured as piezoelectric force-measuring elements (PFEs), the first array and the second array extending along at least one direction including the longitudinal direction; and a signal processor configured to receive PUT array signals from the PUTs and PFE array signals from the PFEs; transmitting, by the transmitting-type PUTs, ultrasound waves towards the cover stack in a predetermined frequency range, the ultrasound waves propagating along a normal direction approximately normal to a plane of the one or more piezoelectric members; receiving, by the receiving-type PUTs, the ultrasound waves from the cover stack in the predetermined frequency range; generating the PUT array signals in accordance with the ultrasound waves received at the receiving-type PUTs; obtaining the PFE array signals from voltage signals generated at the PFEs in response to a low-frequency deformation of the cover stack; calculating, by the signal processor, PUT centroid data from the PUT array signals; calculating, by the signal processor, PFE centroid data from the PFE array signals; determining, by the signal processor, whether a touch event on the cover stack has occurred; and determining, by the signal processor, an estimated touch position on the cover stack by combining applicable centroid data comprising the PUT centroid data and the PFE centroid data, the PUT centroid data being apportioned a PUT fractional weight w(PUT), the PFE centroid data being apportioned a PFE fractional weight w(PFE).

In some aspects, the techniques described herein relate to a method of sensing touch, wherein the PUT fractional weight w(PUT) and the PFE fractional weight w(PFE) are time-varying.

In some aspects, the techniques described herein relate to a method of sensing touch, wherein: the PUT centroid data are characterized by a PUT signal-to-noise ratio (PUT SNR); the PFE centroid data are characterized by a PFE signal-to-noise ratio (PFE SNR); and the PUT fractional weight w(PUT) and the PFE fractional weight w(PFE) vary in accordance with temporal changes to the PUT SNR and/or temporal changes to the PFE SNR.

In some aspects, the techniques described herein relate to a method of sensing touch, wherein: the PUT fractional weight w(PUT) is wₐ(PUT) and the PFE fractional weight w(PFE) is wₐ(PFE) if the PUT SNR is greater than a PUT SNR threshold and the PFE SNR is greater than a PFE SNR threshold, (b) the PUT fractional weight w(PUT) is w_{b}(PUT) and the PFE fractional weight w(PFE) is w_{b}(PFE) if the PUT SNR is not greater than the PUT SNR threshold and the PFE SNR is greater than the PFE SNR threshold, (c) the PUT fractional weight w(PUT) is w_{c}(PUT) and the PFE fractional weight w(PFE) is w_{c}(PFE) if the PUT SNR is greater than the PUT SNR threshold and the PFE SNR is not greater than the PFE SNR threshold; the following relationships are satisfied: w_{b}(PUT)<wₐ(PUT), w_{b}(PFE)>wₐ(PFE), w_{c}(PUT)>wₐ(PUT), and w_{c}(PFE)<wₐ(PFE); and the following relationships are satisfied: wₐ(PUT)+wₐ(PFE)≤1, w_{b}(PUT)+w_{b}(PFE)≤1, and w_{c}(PUT)+w_{c}(PUT)≤1.

In some aspects, the techniques described herein relate to a method of sensing touch, wherein one or more of the following relationships are satisfied: a ratio of wₐ(PUT) to wₐ(PFE) is in a range of 40:60 to 60:40; a ratio of w_{b}(PUT) to w_{b}(PFE) is in a range of 0:100 to 35:65; and a ratio of w_{c}(PUT) to w_{c}(PFE) is in a range of 65:35 to 100:0.

In some aspects, the techniques described herein relate to a method of sensing touch, wherein one or more of the following relationships are satisfied: the ratio of wₐ(PUT) to wₐ(PFE) is in a range of 45:55 to 55:45; the ratio of w_{b}(PUT) to w_{b}(PFE) is in a range of 0:100 to 30:70; and the ratio of w_{c}(PUT) to w_{c}(PFE) is in a range of 70:30 to 100:0.

In some aspects, the techniques described herein relate to a method of sensing touch, wherein the cover stack is configured as at least one button.

In some aspects, the techniques described herein relate to a method of sensing touch, wherein: the touch-sensing system further comprises a third array of additional sensors configured to output additional sensor array signals; the third array extends along the at least one direction; the signal processor is configured to receive the additional sensor array signals; the method further comprises: calculating, by the signal processor, additional sensor centroid data from the additional sensor array signals; and the applicable centroid data further comprise the additional sensor centroid data, the additional sensor centroid data being apportioned an additional sensor fractional weight w(AS).

In some aspects, the techniques described herein relate to a method of sensing touch, wherein the PUT fractional weight w(PUT), the PFE fractional weight w(PFE), and the additional sensor fractional weight w(AS) are time-varying.

In some aspects, the techniques described herein relate to a method of sensing touch, wherein: the PUT centroid data are characterized by a PUT signal-to-noise ratio (PUT SNR); the PFE centroid data are characterized by a PFE signal-to-noise ratio (PFE SNR); the additional sensor centroid data are characterized by an additional sensor signal-to-noise ratio (AS SNR); and the PUT fractional weight w(PUT), the PFE fractional weight w(PFE), and the additional sensor fractional weight w(AS) vary in accordance with temporal changes to one or more of the PUT SNR, the PFE SNR, and the AS SNR.

In some aspects, the techniques described herein relate to a method of sensing touch, wherein the additional sensors are capacitive touch sensors.

In some aspects, the techniques described herein relate to a method of sensing touch, wherein: the capacitive touch sensors are interposed between the cover stack and the piezoelectric capacitors; the capacitive touch sensors are mechanically coupled to the cover stack and the piezoelectric capacitors; and the cover stack is electrically non-conductive.

In some aspects, the techniques described herein relate to a method of sensing touch, wherein: the cover stack is a first cover stack; the piezoelectric capacitors are first piezoelectric capacitors; the touch-sensing system further comprises: a second cover stack adjacent the first cover stack, having an outer surface that can be touched by the finger; and one or more second piezoelectric capacitors mechanically coupled to the second cover stack at its inner surface, the second cover stack overlying the one or more second piezoelectric capacitors; the one or more second piezoelectric capacitors are configured as PUTs and/or PFEs; the signal processor is configured to receive second piezoelectric capacitor signals from the one or more second piezoelectric capacitors; and the method further comprises: determining, by the signal processor, whether a touch event on the second cover stack has occurred, from at least the second piezoelectric capacitor signals; and determining, by the signal processor an estimated touch position on the second cover stack, from at least the second piezoelectric capacitor signals.

In some aspects, the techniques described herein relate to a method of sensing touch, wherein the second cover stack is configured as a frame.

In some aspects, the techniques described herein relate to a method of sensing touch, wherein the second cover stack is electrically conductive.

In some aspects, the techniques described herein relate to a method of sensing touch, wherein the additional sensors are steady-state force sensors.

In some aspects, the techniques described herein relate to a method of sensing touch, wherein the steady-state force sensors are strain gauges or parallel plate force sensors.

In some aspects, the techniques described herein relate to a method of sensing touch, wherein: the touch-sensing system further comprises a haptic module comprising a haptic actuator and a haptic controller, the haptic actuator being vibrationally coupled to the cover stack; and the method further comprises driving, by the haptic controller, the haptic actuator in accordance with haptic feedback commands from the signal processor.

In some aspects, the techniques described herein relate to a touch-sensing system, comprising: a cover stack having an outer surface that can be touched by a finger, the cover stack having a longitudinal direction along which the finger can touch and slide on the outer surface; piezoelectric capacitors mechanically coupled to the cover stack at its inner interface, the cover stack overlying the piezoelectric capacitors, the piezoelectric capacitors comprising one or more piezoelectric members; an array of at least two of the piezoelectric capacitors configured as piezoelectric ultrasonic transducers (PUTs); one of the piezoelectric capacitors configured as a piezoelectric force-measuring element (PFE); and a signal processor configured to receive PUT array signals from the PUTs and PFE signals from the PFE, wherein: each of the PUTs is configured as a transmitting-type PUT and/or a receiving-type PUT, the receiving-type PUTs numbering at least two in the array; the array extends along at least one direction including the longitudinal direction; the transmitting-type PUTs are configured to transmit ultrasound waves towards the cover stack in a predetermined frequency range, the ultrasound waves propagating along a normal direction approximately normal to a plane of the one or more piezoelectric members; the receiving-type PUTs are configured to receive the ultrasound waves from the cover stack in the predetermined frequency range; the PUT array signals are generated in accordance with the ultrasound waves received at the receiving-type PUTs; the PFE signals are obtained from voltage signals generated at the PFE in response to a low-frequency deformation of the cover stack; the signal processor is configured to calculate, from the PUT array signals, PUT centroid data; the signal processor is configured to determine whether a touch event on the cover stack has occurred, in accordance with applicable data comprising the PUT centroid data and the PFE signals; and the signal processor is configured to determine an estimated touch position on the cover stack in accordance with the PUT centroid data.

In some aspects, the techniques described herein relate to a touch-sensing system, further comprising: an additional sensor configured to output additional sensor signals, wherein: the signal processor is configured to receive the additional sensor signals; and the applicable data further comprise the additional sensor signals.

In some aspects, the techniques described herein relate to a touch-sensing system, wherein the additional sensor is a steady-state force sensor.

In some aspects, the techniques described herein relate to a touch-sensing system, wherein the steady-state force sensor is a strain gauge or a parallel plate force sensor.

In some aspects, the techniques described herein relate to a touch-sensing system, further comprising: a haptic module comprising a haptic actuator and a haptic controller, the haptic actuator being vibrationally coupled to the cover stack, wherein the haptic controller is configured to drive the haptic actuator in accordance with haptic feedback commands from the signal processor.

In some aspects, the techniques described herein relate to a touch-sensing system, wherein at least two of the piezoelectric capacitors share a common piezoelectric member among the one or more piezoelectric members.

In some aspects, the techniques described herein relate to a touch-sensing system, wherein at least two of the piezoelectric capacitors share a common electrode.

In some aspects, the techniques described herein relate to a touch-sensing system, wherein: the PUTs are piezoelectric micromechanical ultrasonic transducers (PMUTs); the PFE is a piezoelectric micromechanical force-measuring elements (PMFE); and the PMUTs and the PMFE are part of a monolithic IC.

In some aspects, the techniques described herein relate to a touch-sensing system, wherein the monolithic IC comprises the signal processor.

In some aspects, the techniques described herein relate to a touch-sensing system, wherein at least one of the piezoelectric capacitors are adhered to the cover stack at the inner interface by an adhesive comprising double-sided tape, pressure sensitive adhesive (PSA), epoxy adhesive, or acrylic adhesive.

In some aspects, the techniques described herein relate to a touch-sensing system, wherein: at least the piezoelectric capacitors are encapsulated in a molded package; and at least a portion of the molded package is configured as the cover stack.

In some aspects, the techniques described herein relate to a touch-sensing system, wherein the one or more piezoelectric members comprise aluminum nitride, scandium-doped aluminum nitride, polyvinylidene fluoride (PVDF), lead zirconate titanate (PZT), potassium sodium niobate (KₓNa₁₋ₓNbO₃) (KNN), barium titanate (BaTiO₃) (BT), bismuth ferrite (BiFeO₃) (BFO), quartz, zinc oxide, lithium niobate, or bismuth sodium titanate (Bi_{0.5}Na_{0.5}TiO₃) (BNT).

In some aspects, the techniques described herein relate to a method of sensing touch, the method comprising: providing a touch-sensing system, comprising: a cover stack having an outer surface that can be touched by a finger, the cover stack having a longitudinal direction along which the finger can touch and slide on the outer surface; piezoelectric capacitors mechanically coupled to the cover stack at its inner interface, the cover stack overlying the piezoelectric capacitors, the piezoelectric capacitors comprising one or more piezoelectric members; an array of at least two of the piezoelectric capacitors configured as piezoelectric ultrasonic transducers (PUTs), each of the PUTs being configured as a transmitting-type PUT and/or a receiving-type PUT, the receiving-type PUTs numbering at least two in the array, the array extending along at least one direction including the longitudinal direction; one of the piezoelectric capacitors configured as a piezoelectric force-measuring element (PFE); and a signal processor configured to receive PUT array signals from the PUTs and PFE signals from the PFE; transmitting, by the transmitting-type PUTs, ultrasound waves towards the cover stack in a predetermined frequency range, the ultrasound waves propagating along a normal direction approximately normal to a plane of the one or more piezoelectric members; receiving, by the receiving-type PUTs, the ultrasound waves from the cover stack in the predetermined frequency range; generating the PUT array signals in accordance with the ultrasound waves received at the receiving-type PUTs; obtaining the PFE signals from voltage signals generated at the PFE in response to a low-frequency deformation of the cover stack; calculating, by the signal processor, PUT centroid data from the PUT array signals; determining, by the signal processor, whether a touch event on the cover stack has occurred, in accordance with applicable data comprising the PUT centroid data and the PFE signals; and determining, by the signal processor, an estimated touch position on the cover stack in accordance with the PUT centroid data.

In some aspects, the techniques described herein relate to a method of sensing touch, wherein: the touch-sensing system further comprises an additional sensor configured to output additional sensor signals, the signal processor is configured to receive the additional sensor signals; and the applicable data further comprises the additional sensor signals.

In some aspects, the techniques described herein relate to a method of sensing touch, wherein the additional sensor is a steady-state force sensor.

In some aspects, the techniques described herein relate to a method of sensing touch, wherein the steady-state force sensor is a strain gauge or a parallel plate force sensor.

In some aspects, the techniques described herein relate to a method of sensing touch, wherein: the touch-sensing system further comprises a haptic module comprising a haptic actuator and a haptic controller, the haptic actuator vibrationally coupled to the cover stack; and the method further comprises: driving, by the haptic controller, the haptic actuator in accordance with haptic feedback commands from the signal processor.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A touch-sensing system, comprising:
a cover stack having an outer surface that can be touched by a finger, the cover stack having a longitudinal direction along which the finger can touch and slide on the outer surface;
piezoelectric capacitors mechanically coupled to the cover stack at its inner interface, the cover stack overlying the piezoelectric capacitors, the piezoelectric capacitors comprising one or more piezoelectric members;
a first array of at least two of the piezoelectric capacitors configured as piezoelectric ultrasonic transducers (PUTs);
a second array of at least two of the piezoelectric capacitors configured as piezoelectric force-measuring elements (PFEs); and
a signal processor configured to receive PUT array signals from the PUTs and PFE array signals from the PFEs,
wherein:
each of the PUTs is configured as a transmitting-type PUT and/or a receiving-type PUT, the receiving-type PUTs numbering at least two in the first array;
the first array and the second array extend along at least one direction including the longitudinal direction;
the transmitting-type PUTs are configured to transmit ultrasound waves towards the cover stack in a predetermined frequency range, the ultrasound waves propagating along a normal direction approximately normal to a plane of the one or more piezoelectric members;
the receiving-type PUTs are configured to receive the ultrasound waves from the cover stack in the predetermined frequency range;
the PUT array signals are generated in accordance with the ultrasound waves received at the receiving-type PUTs;
the PFE array signals are obtained from voltage signals generated at the PFEs in response to a low-frequency deformation of the cover stack;
the signal processor is configured to calculate, from the PUT array signals, PUT centroid data;
the signal processor is configured to calculate, from the PFE array signals, PFE centroid data;
the signal processor is configured to determine, whether a touch event on the cover stack has occurred; and
the signal processor is configured to determine an estimated touch position on the cover stack by combining applicable centroid data comprising the PUT centroid data and the PFE centroid data, the PUT centroid data being apportioned a PUT fractional weight w(PUT), the PFE centroid data being apportioned a PFE fractional weight w(PFE).

2. The touch-sensing system of claim 1, wherein the PUT fractional weight w(PUT) and the PFE fractional weight w(PFE) are time-varying.

3. The touch-sensing system of claim 2, wherein:
the PUT centroid data are characterized by a PUT signal-to-noise ratio (PUT SNR);
the PFE centroid data are characterized by a PFE signal-to-noise ratio (PFE SNR); and
the PUT fractional weight w(PUT) and the PFE fractional weight w(PFE) vary in accordance with temporal changes to the PUT SNR and/or temporal changes to the PFE SNR.

4. The touch-sensing system of claim 3, wherein:
the PUT fractional weight w(PUT) is wₐ(PUT) and the PFE fractional weight w(PFE) is wₐ(PFE) if the PUT SNR is greater than a PUT SNR threshold and the PFE SNR is greater than a PFE SNR threshold, (b) the PUT fractional weight w(PUT) is w_{b}(PUT) and the PFE fractional weight w(PFE) is w_{b}(PFE) if the PUT SNR is not greater than the PUT SNR threshold and the PFE SNR is greater than the PFE SNR threshold, (c) the PUT fractional weight w(PUT) is w_{c}(PUT) and the PFE fractional weight w(PFE) is w_{c}(PFE) if the PUT SNR is greater than the PUT SNR threshold and the PFE SNR is not greater than the PFE SNR threshold;
the following relationships are satisfied: w_{b}(PUT)<wₐ(PUT), w_{b}(PFE)>wₐ(PFE), w_{c}(PUT)>wₐ(PUT), and w_{c}(PFE)<wₐ(PFE); and
the following relationships are satisfied: wₐ(PUT)+wₐ(PFE)≤1, w_{b}(PUT)+w_{b}(PFE)≤1, and w_{c}(PUT)+w_{c}(PUT)≤1.

5. The touch-sensing system of claim 4, wherein one or more of the following relationships are satisfied:
a ratio of wₐ(PUT) to wₐ(PFE) is in a range of 40:60 to 60:40;
a ratio of w_{b}(PUT) to w_{b}(PFE) is in a range of 0:100 to 35:65; and
a ratio of w_{c}(PUT) to w_{c}(PFE) is in a range of 65:35 to 100:0.

6. The touch-sensing system of claim 5, wherein one or more of the following relationships are satisfied:
the ratio of wₐ(PUT) to wₐ(PFE) is in a range of 45:55 to 55:45;
the ratio of w_{b}(PUT) to w_{b}(PFE) is in a range of 0:100 to 30:70; and
the ratio of w_{c}(PUT) to w_{c}(PFE) is in a range of 70:30 to 100:0.

7. The touch-sensing system of claim 1, wherein the cover stack is configured as at least one button.

8. The touch-sensing system of claim 1, further comprising:
a haptic module comprising a haptic actuator and a haptic controller, the haptic actuator being vibrationally coupled to the cover stack,
wherein the haptic controller is configured to drive the haptic actuator in accordance with haptic feedback commands from the signal processor.

9. The touch-sensing system of claim 1, wherein at least two of the piezoelectric capacitors share a common piezoelectric member among the one or more piezoelectric members.

10. The touch-sensing system of claim 1, wherein at least two of the piezoelectric capacitors share a common electrode.

11. The touch-sensing system of claim 1, wherein:
the PUTs are piezoelectric micromechanical ultrasonic transducers (PMUTs);
the PFEs are piezoelectric micromechanical force-measuring elements (PMFEs); and
the PMUTs and the PMFEs are part of a monolithic IC.

12. The touch-sensing system of claim 11, wherein the monolithic IC comprises the signal processor.

13. The touch-sensing system of claim 1, wherein at least one of the piezoelectric capacitors are adhered to the cover stack at the inner interface by an adhesive comprising double-sided tape, pressure sensitive adhesive (PSA), epoxy adhesive, or acrylic adhesive.

14. The touch-sensing system of claim 1, wherein:
at least the piezoelectric capacitors are encapsulated in a molded package; and
at least a portion of the molded package is configured as the cover stack.

15. The touch-sensing system of claim 1, wherein the one or more piezoelectric members comprise aluminum nitride, scandium-doped aluminum nitride, polyvinylidene fluoride (PVDF), lead zirconate titanate (PZT), potassium sodium niobate (KₓNa₁₋ₓNbO₃) (KNN), barium titanate (BaTiO₃) (BT), bismuth ferrite (BiFeO₃) (BFO), quartz, zinc oxide, lithium niobate, or bismuth sodium titanate (Bi_{0.5}Na_{0.5}TiO₃) (BNT).

16. A method of sensing touch, the method comprising:
providing a touch-sensing system, comprising:
a cover stack having an outer surface that can be touched by a finger, the cover stack having a longitudinal direction along which the finger can touch and slide on the outer surface;
piezoelectric capacitors mechanically coupled to the cover stack at its inner interface, the cover stack overlying the piezoelectric capacitors, the piezoelectric capacitors comprising one or more piezoelectric members;
a first array of at least two of the piezoelectric capacitors configured as piezoelectric ultrasonic transducers (PUTs), each of the PUTs being configured as a transmitting-type PUT and/or a receiving-type PUT, the receiving-type PUTs numbering at least two in the first array;
a second array of at least two of the piezoelectric capacitors configured as piezoelectric force-measuring elements (PFEs), the first array and the second array extending along at least one direction including the longitudinal direction; and
a signal processor configured to receive PUT array signals from the PUTs and PFE array signals from the PFEs;
transmitting, by the transmitting-type PUTs, ultrasound waves towards the cover stack in a predetermined frequency range, the ultrasound waves propagating along a normal direction approximately normal to a plane of the one or more piezoelectric members;
receiving, by the receiving-type PUTs, the ultrasound waves from the cover stack in the predetermined frequency range;
generating the PUT array signals in accordance with the ultrasound waves received at the receiving-type PUTs;
obtaining the PFE array signals from voltage signals generated at the PFEs in response to a low-frequency deformation of the cover stack;
calculating, by the signal processor, PUT centroid data from the PUT array signals;
calculating, by the signal processor, PFE centroid data from the PFE array signals;
determining, by the signal processor, whether a touch event on the cover stack has occurred; and
determining, by the signal processor, an estimated touch position on the cover stack by combining applicable centroid data comprising the PUT centroid data and the PFE centroid data, the PUT centroid data being apportioned a PUT fractional weight w(PUT), the PFE centroid data being apportioned a PFE fractional weight w(PFE).

17. The method of claim 16, wherein the PUT fractional weight w(PUT) and the PFE fractional weight w(PFE) are time-varying.

18. The method of claim 17, wherein:
the PUT centroid data are characterized by a PUT signal-to-noise ratio (PUT SNR);
the PFE centroid data are characterized by a PFE signal-to-noise ratio (PFE SNR); and
the PUT fractional weight w(PUT) and the PFE fractional weight w(PFE) vary in accordance with temporal changes to the PUT SNR and/or temporal changes to the PFE SNR.

19. The method of claim 18, wherein:
the PUT fractional weight w(PUT) is wₐ(PUT) and the PFE fractional weight w(PFE) is wₐ(PFE) if the PUT SNR is greater than a PUT SNR threshold and the PFE SNR is greater than a PFE SNR threshold, (b) the PUT fractional weight w(PUT) is w_{b}(PUT) and the PFE fractional weight w(PFE) is w_{b}(PFE) if the PUT SNR is not greater than the PUT SNR threshold and the PFE SNR is greater than the PFE SNR threshold, (c) the PUT fractional weight w(PUT) is w_{c}(PUT) and the PFE fractional weight w(PFE) is w_{c}(PFE) if the PUT SNR is greater than the PUT SNR threshold and the PFE SNR is not greater than the PFE SNR threshold;
the following relationships are satisfied: w_{b}(PUT)<wₐ(PUT), w_{b}(PFE)>wₐ(PFE), w_{c}(PUT)>wₐ(PUT), and w_{c}(PFE)<wₐ(PFE); and
the following relationships are satisfied: wₐ(PUT)+wₐ(PFE)≤1, w_{b}(PUT)+w_{b}(PFE)≤1, and w_{c}(PUT)+w_{c}(PUT)≤1.

20. The method of claim 19, wherein one or more of the following relationships are satisfied:
a ratio of wₐ(PUT) to wₐ(PFE) is in a range of 40:60 to 60:40;
a ratio of w_{b}(PUT) to w_{b}(PFE) is in a range of 0:100 to 35:65; and
a ratio of w_{c}(PUT) to w_{c}(PFE) is in a range of 65:35 to 100:0.

21. The method of claim 20, wherein one or more of the following relationships are satisfied:
the ratio of wₐ(PUT) to wₐ(PFE) is in a range of 45:55 to 55:45;
the ratio of w_{b}(PUT) to w_{b}(PFE) is in a range of 0:100 to 30:70; and
the ratio of w_{c}(PUT) to w_{c}(PFE) is in a range of 70:30 to 100:0.

22. The method of claim 16, wherein the cover stack is configured as at least one button.

23. The method of claim 16, wherein:
the touch-sensing system further comprises a haptic module comprising a haptic actuator and a haptic controller, the haptic actuator being vibrationally coupled to the cover stack; and
the method further comprises driving, by the haptic controller, the haptic actuator in accordance with haptic feedback commands from the signal processor.
